(19) United States
(12) Patent Application Publication
(10) Pub. No.: US 2025/0004350 A1
(43) Pub. Date: Jan. 2, 2025

(54) GRATING CONFIGURATIONS FOR OPTICAL BEAM STEERING

(71) Applicant: Analog Photonics LLC, Boston, MA (US)

(72) Inventors: Jonathan Andrew Guglielmon, Cambridge, MA (US); Hao Yang, Boston, MA (US); Michael Robert Watts, Hingham, MA (US)

(73) Assignee: Analog Photonics LLC, Boston, MA (US)

(21) Appl. No.: 18/753,553

(22) Filed: Jun. 25, 2024

Related U.S. Application Data
(60) Provisional application No. 63/523,685, filed on Jun. 28, 2023.

(51) Int. Cl. G02F 1/295; G02B 6/124; G02B 27/00

(52) U.S. Cl. CPC G02F 1/2955; G02B 6/124; G02B 27/0087; G02F 2201/30

(57) ABSTRACT

An apparatus comprises: at least one optical source port providing an optical wave having a tunable spectral peak wavelength; one or more transmitting optical phased arrays (OPAs), each: coupled to the optical source port, wherein the OPAs form beams with a wavelength-controlled angular tuning range within a first plane and a phase-shift-controlled angular tuning range within a perpendicular plane; and receiving OPAs, each: coupled to a coherent receiver and configured to receive optical waves characterized by a wavelength-controlled angular tuning range within the first plane and a phase-shift-controlled angular tuning range within the perpendicular plane. At least two beams' wavelength-controlled angular tuning ranges are at least partially non-overlapping, and each of the receiving OPAs' wavelength-controlled angular tuning ranges at least one partially overlaps with at least one of the wavelength-controlled angular tuning ranges of the beams.

### CROSS-REFERENCE TO RELATED APPLICATION(S)

This application claims priority to and the benefit of U.S. Provisional Application Ser. No. 63/523,685 entitled “GRATING CONFIGURATIONS FOR OPTICAL BEAM STEERING,” filed Jun. 28, 2023, the entire disclosure of which is hereby incorporated by reference.

### TECHNICAL FIELD

This disclosure relates to grating configurations for optical beam steering.

### BACKGROUND

Some photonic integrated circuits (PICs) can enable beam steering, for example, by using one or more optical phased arrays (OPAs). Some OPAs have a linear distribution of grating antennas (also called grating elements). Steering about a first axis perpendicular to the linear distribution can be provided by changing the relative phase shifts in phase shifters feeding each of the grating antennas. This beam steering can be performed in a solid-state manner, rapidly, and potentially with random-access, but may be limited to one dimension.

One application of such beam steering may occur in a light detection and ranging (LiDAR) system, where an optical wave from an optical source can be transmitted using an OPA to target object(s) at a given distance and the light backscattered from the target object(s) can be collected using another OPA. Various techniques, such as modulation and/or time of flight, can be used to determine distance to a target object based on information associated with a detection event. The optical source used in such a system can be a laser or other coherent light source, which provides an optical wave that has as narrow linewidth and has a peak wavelength that falls in a particular range (e.g., between about 100 nm to about 1 mm, or some subrange thereof), also referred to herein as simply “light”. Another application in which beam steering may be relevant is in free-space optical communications.

### SUMMARY

In one aspect, in general, an apparatus comprises: at least one optical source port providing an optical wave having a spectral peak wavelength that is tunable; one or more transmitting optical phased arrays (OPAs), each transmitting OPA of the one or more transmitting OPAs: being coupled to the optical source port, and comprising a plurality of optical phase shifters that are tunable, and a plurality of optical grating antennas, including two or more optical grating antennas each coupled to a different respective one of the optical phase shifters, wherein the one or more transmitting OPAs are configured to form a plurality of beams each characterized by a wavelength-controlled angular tuning range within a first plane and a phase-shift-controlled angular tuning range within a plane perpendicular to the first plane; and a plurality of receiving OPAs, each receiving OPA of the plurality of receiving OPAs: being coupled to a coherent receiver that is coupled to the optical source port, comprising a plurality of optical phase shifters that are tunable, and a plurality of optical grating antennas, including two or more optical grating antennas each coupled to a different respective one of the optical phase shifters, and being configured to receive optical waves from a set of receiving angles characterized by a wavelength-controlled angular tuning range within the first plane and a phase-shift-controlled angular tuning range within a plane perpendicular to the first plane; wherein at least two of the wavelength-controlled angular tuning ranges of the plurality of beams are at least partially non-overlapping, and each of the wavelength-controlled angular tuning ranges of the plurality of receiving OPAs at least partially overlaps with at least one of the wavelength-controlled angular tuning ranges of the plurality of beams.

Aspects can include one or more of the following features.

The one or more transmitting OPAs comprise a plurality of transmitting OPAs, and each transmitting OPA of the plurality of transmitting OPAs is configured to form a different one of the plurality of beams.

At least one of the one or more transmitting OPAs comprises: at least one waveguide configured to guide an optical wave along a propagation axis; a plurality of sets of grating elements distributed along the waveguide and configured to perturb a portion of the optical wave as it propagates along the waveguide to emit a plurality of beams at different respective angles about an axis that is perpendicular to the propagation axis, the plurality of sets of grating elements comprising: a first set of grating elements with adjacent grating elements separated from each other along the propagation axis by a first length, and a second set of grating elements with adjacent grating elements separated from each other along the propagation axis by the first length, where the second set of grating elements is separated from the first set of grating elements along the propagation axis by a gap without any grating elements at least twice as large as the first length.

Each grating element of the plurality of sets of grating elements is in contact with a strip of material having substantially the same index of refraction as the grating elements.

The one or more transmitting OPAs consist of a single transmitting OPA configured to form the plurality of beams.

Each grating element of the plurality of sets of grating elements extends along a direction substantially perpendicular to the propagation axis.

Each grating element of the plurality of sets of grating elements comprises: a first portion positioned to perturb a first portion of a wavefront of the optical wave at a first location along the propagation axis, and a second portion positioned to perturb a second portion of the wavefront at a second location along the propagation axis different from the first location, where the second portion of the wavefront is at least partially non-overlapping with the first portion of the wavefront.

In another aspect, in general, a method for managing optical phased array beam steering comprises: providing, from at least one optical source port, an optical wave having a spectral peak wavelength that is tunable; transmitting a plurality of beams from one or more transmitting optical phased arrays (OPAs), each transmitting OPA of the one or more transmitting OPAs: being coupled to the optical source port, and comprising a plurality of optical phase shifters that are tunable, and a plurality of optical grating antennas, including two or more optical grating antennas each coupled to a different respective one of the optical phase shifters, wherein the one or more transmitting OPAs are configured to form the plurality of beams each characterized by a wavelength-controlled angular tuning range within a first plane and a phase-shift-controlled angular tuning range within a plane perpendicular to the first plane; and receiving optical waves into a plurality of receiving OPAs, each receiving OPA of the plurality of receiving OPAs: being coupled to a coherent receiver that is coupled to the optical source port, comprising a plurality of optical phase shifters that are tunable, and a plurality of optical grating antennas, including two or more optical grating antennas each coupled to a different respective one of the optical phase shifters, and being configured to receive optical waves from a set of receiving angles characterized by a wavelength-controlled angular tuning range within the first plane and a phase-shift-controlled angular tuning range within a plane perpendicular to the first plane; wherein at least two of the wavelength-controlled angular tuning ranges of the plurality of beams are at least partially non-overlapping, and each of the wavelength-controlled angular tuning ranges of the plurality of receiving OPAs at least partially overlaps with at least one of the wavelength-controlled angular tuning ranges of the plurality of beams.

In another aspect, in general, an apparatus comprises: at least one waveguide configured to guide an optical wave along a propagation axis; and a plurality of sets of grating elements distributed along the waveguide and configured to perturb a portion of the optical wave as it propagates along the waveguide to emit a plurality of beams at different respective angles about an axis that is perpendicular to the propagation axis, the plurality of sets of grating elements comprising: a first set of grating elements with adjacent grating elements separated from each other along the propagation axis by a first length, and a second set of grating elements with adjacent grating elements separated from each other along the propagation axis by the first length, where the second set of grating elements is separated from the first set of grating elements along the propagation axis by a gap without any grating elements at least twice as large as the first length.

Aspects can include one or more of the following features.

The apparatus further comprises: at least one optical source port providing an optical wave having a spectral peak wavelength that is tunable; a transmitting optical phased array (OPA): being coupled to the optical source port, and comprising a plurality of optical phase shifters that are tunable, and a plurality of optical grating antennas, including two or more optical grating antennas each coupled to a different respective one of the optical phase shifters, each of the optical grating antennas comprising a structure substantially identical to the waveguide and the plurality of sets of grating elements, and being configured to form a plurality of beams each characterized by a wavelength-controlled angular tuning range within a first plane and a phase-shift-controlled angular tuning range within a plane perpendicular to the first plane; and a plurality of receiving OPAs, each receiving OPA of the plurality of receiving OPAs: being coupled to a coherent receiver that is coupled to the optical source port, comprising a plurality of optical phase shifters that are tunable, and a plurality of optical grating antennas, including two or more optical grating antennas each coupled to a different respective one of the optical phase shifters, and being configured to receive optical waves from a set of receiving angles characterized by a wavelength-controlled angular tuning range within the first plane and a phase-shift-controlled angular tuning range within a plane perpendicular to the first plane.

At least two of the wavelength-controlled angular tuning ranges of the plurality of beams are at least partially non-overlapping, and each of the wavelength-controlled angular tuning ranges of the plurality of receiving OPAs at least partially overlaps with at least one of the wavelength-controlled angular tuning ranges of the plurality of beams.

Each grating element of the plurality of sets of grating elements is in contact with a strip of material having substantially the same index of refraction as the grating elements.

Each grating element of the plurality of sets of grating elements comprises: a first portion positioned to perturb a first portion of a wavefront of the optical wave at a first location along the propagation axis, and a second portion positioned to perturb a second portion of the wavefront at a second location along the propagation axis different from the first location, where the second portion of the wavefront is at least partially non-overlapping with the first portion of the wavefront.

In another aspect, in general, a method for fabricating an optical device comprises: forming at least one waveguide configured to guide an optical wave along a propagation axis; and forming a plurality of sets of grating elements distributed along the waveguide and configured to perturb a portion of the optical wave as it propagates along the waveguide to emit a plurality of beams at different respective angles about an axis that is perpendicular to the propagation axis, the plurality of sets of grating elements comprising: a first set of grating elements with adjacent grating elements separated from each other along the propagation axis by a first length, and a second set of grating elements with adjacent grating elements separated from each other along the propagation axis by the first length, where the second set of grating elements is separated from the first set of grating elements along the propagation axis by a gap without any grating elements at least twice as large as the first length.

In another aspect, in general, an apparatus comprises: at least one waveguide configured to guide an optical wave along a propagation axis; and a plurality of grating elements distributed along the waveguide and configured to perturb a portion of the optical wave as it propagates along the waveguide, each of the plurality of grating elements comprising: a first portion positioned to perturb a first portion of a wavefront of the optical wave at a first location along the propagation axis, and a second portion positioned to perturb a second portion of the wavefront at a second location along the propagation axis different from the first location, where the second portion of the wavefront is at least partially non-overlapping with the first portion of the wavefront.

Aspects can include one or more of the following features.

Each of the plurality of grating elements comprises: the first portion in contact with the waveguide at the first location and extending along a direction substantially perpendicular to the propagation axis, and the second portion in contact with the waveguide at the second location and extending along a direction substantially perpendicular to the propagation axis.

The first portion and the second portion of a particular grating element are connected to each other.

The first portion and the second portion of a particular grating element are connected to each other.

Each of the plurality of grating elements comprises: the first portion in contact with the waveguide at a third location and extending to at least the first location, and the second portion in contact with the waveguide at the third location and extending to at least the second location.

The particular grating element extends along a substantially straight line that is at an angle that is not perpendicular to the propagation axis.

The apparatus further comprises: at least one optical source port providing an optical wave having a spectral peak wavelength that is tunable; a plurality transmitting optical phased arrays (OPAs), each transmitting OPA of the plurality of transmitting OPAs: being coupled to the optical source port, comprising a plurality of optical phase shifters that are tunable, and a plurality of optical grating antennas, including two or more optical grating antennas each coupled to a different respective one of the optical phase shifters, each of the optical grating antennas comprising a structure substantially identical to the waveguide and the plurality grating elements, and being configured to form a beam characterized by a wavelength-controlled angular tuning range within a first plane and a phase-shift-controlled angular tuning range within a plane perpendicular to the first plane; and a plurality of receiving OPAs, each receiving OPA of the plurality of receiving OPAs: being coupled to a coherent receiver that is coupled to the optical source port, comprising a plurality of optical phase shifters that are tunable, and a plurality of optical grating antennas, including two or more optical grating antennas each coupled to a different respective one of the optical phase shifters, each of the optical grating antennas comprising a structure substantially identical to the waveguide and the plurality grating elements, and being configured to receive optical waves from a set of receiving angles characterized by a wavelength-controlled angular tuning range within the first plane and a phase-shift-controlled angular tuning range within a plane perpendicular to the first plane.

At least two of the wavelength-controlled angular tuning ranges of the beams of the plurality of transmitting OPAs are at least partially non-overlapping and each of plurality of receiving OPAs has a wavelength-controlled angular tuning range that at least partially overlaps with a wavelength-controlled angular tuning range of at least one of the beams of the plurality of transmitting OPAs, or at least two of the phase-shift-controlled angular tuning ranges of the beams of the plurality of transmitting OPAs are at least partially non-overlapping and each of plurality of receiving OPAs has a phase-shift-controlled angular tuning range that at least partially overlaps with a phase-shift-controlled angular tuning range of at least one of the beams of the plurality of transmitting OPAs.

In another aspect, in general, a method for fabricating an optical device comprises: forming at least one waveguide configured to guide an optical wave along a propagation axis; and forming a plurality of grating elements distributed along the waveguide and configured to perturb a portion of the optical wave as it propagates along the waveguide, each of the plurality of grating elements comprising: a first portion positioned to perturb a first portion of a wavefront of the optical wave at a first location along the propagation axis, and a second portion positioned to perturb a second portion of the wavefront at a second location along the propagation axis different from the first location, where the second portion of the wavefront is at least partially non-overlapping with the first portion of the wavefront.

In another aspect, in general, an apparatus comprises: at least one optical source port providing an optical wave having a spectral peak wavelength that is tunable; a plurality transmitting optical phased arrays (OPAs), each transmitting OPA of the plurality of transmitting OPAs: being coupled to the optical source port, comprising a plurality of optical phase shifters that are tunable, and a plurality of optical grating antennas, including two or more optical grating antennas each coupled to a different respective one of the optical phase shifters, and being configured to form a beam characterized by a wavelength-controlled angular tuning range within a first plane and a phase-shift-controlled angular tuning range within a plane perpendicular to the first plane; and a plurality of receiving OPAs, each receiving OPA of the plurality of receiving OPAs: being coupled to a coherent receiver that is coupled to the optical source port, comprising a plurality of optical phase shifters that are tunable, and a plurality of optical grating antennas, including two or more optical grating antennas each coupled to a different respective one of the optical phase shifters, and being configured to receive optical waves from a set of receiving angles characterized by a wavelength-controlled angular tuning range within the first plane and a phase-shift-controlled angular tuning range within a plane perpendicular to the first plane; wherein at least two of the wavelength-controlled angular tuning ranges of the beams of the plurality of transmitting OPAs are at least partially non-overlapping and each of plurality of receiving OPAs has a wavelength-controlled angular tuning range that at least partially overlaps with a wavelength-controlled angular tuning range of at least one of the beams of the plurality of transmitting OPAs, or at least two of the phase-shift-controlled angular tuning ranges of the beams of the plurality of transmitting OPAs are at least partially non-overlapping and each of plurality of receiving OPAs has a phase-shift-controlled angular tuning range that at least partially overlaps with a phase-shift-controlled angular tuning range of at least one of the beams of the plurality of transmitting OPAs.

Aspects can include one or more of the following features.

At least two of the wavelength-controlled angular tuning ranges of the beams of the plurality of transmitting OPAs are at least partially non-overlapping and each of plurality of receiving OPAs has a wavelength-controlled angular tuning range that at least partially overlaps with a wavelength-controlled angular tuning range of at least one of the beams of the plurality of transmitting OPAs.

At least two of the phase-shift-controlled angular tuning ranges of the beams of the plurality of transmitting OPAs are at least partially non-overlapping and each of plurality of receiving OPAs has a phase-shift-controlled angular tuning range that at least partially overlaps with a phase-shift-controlled angular tuning range of at least one of the beams of the plurality of transmitting OPAs.

At least two of the wavelength-controlled angular tuning ranges of the beams of the plurality of transmitting OPAs are at least partially non-overlapping and each of plurality of receiving OPAs has a wavelength-controlled angular tuning range that at least partially overlaps with a wavelength-controlled angular tuning range of at least one of the beams of the plurality of transmitting OPAs, and at least two of the phase-shift-controlled angular tuning ranges of the beams of the plurality of transmitting OPAs are at least partially non-overlapping and each of plurality of receiving OPAs has a phase-shift-controlled angular tuning range that at least partially overlaps with a phase-shift-controlled angular tuning range of at least one of the beams of the plurality of transmitting OPAs.

At least one of the plurality of transmitting OPAs comprises: at least one waveguide configured to guide an optical wave along a propagation axis; a plurality of sets of grating elements distributed along the waveguide and configured to perturb a portion of the optical wave as it propagates along the waveguide to emit a plurality of beams at different respective angles about an axis that is perpendicular to the propagation axis, the plurality of sets of grating elements comprising: a first set of grating elements with adjacent grating elements separated from each other along the propagation axis by a first length, and a second set of grating elements with adjacent grating elements separated from each other along the propagation axis by the first length, where the second set of grating elements is separated from the first set of grating elements along the propagation axis by a gap without any grating elements at least twice as large as the first length.

Each grating element of the plurality of sets of grating elements is in contact with a strip of material having substantially the same index of refraction as the grating elements.

At least one of the plurality of transmitting OPAs comprises: at least one waveguide configured to guide an optical wave along a propagation axis; a plurality of grating elements distributed along the waveguide and configured to perturb a portion of the optical wave as it propagates along the waveguide to emit a plurality of beams at different respective angles about an axis that is perpendicular to the propagation axis, the plurality of grating elements comprising: a first portion positioned to perturb a first portion of a wavefront of the optical wave at a first location along the propagation axis, and a second portion positioned to perturb a second portion of the wavefront at a second location along the propagation axis different from the first location, where the second portion of the wavefront is at least partially non-overlapping with the first portion of the wavefront.

The first and the second portion of a particular grating element are connected to each other.

In another aspect, in general, a method for managing optical phased array beam steering comprises: providing, from at least one optical source port, an optical wave having a spectral peak wavelength that is tunable; transmitting beams from a plurality transmitting optical phased arrays (OPAs), each transmitting OPA of the plurality of transmitting OPAs: being coupled to the optical source port, comprising a plurality of optical phase shifters that are tunable, and a plurality of optical grating antennas, including two or more optical grating antennas each coupled to a different respective one of the optical phase shifters, and being configured to form a beam characterized by a wavelength-controlled angular tuning range within a first plane and a phase-shift-controlled angular tuning range within a plane perpendicular to the first plane; and receiving optical waves into a plurality of receiving OPAs, each receiving OPA of the plurality of receiving OPAs: being coupled to a coherent receiver that is coupled to the optical source port, comprising a plurality of optical phase shifters that are tunable, and a plurality of optical grating antennas, including two or more optical grating antennas each coupled to a different respective one of the optical phase shifters, and being configured to receive optical waves from a set of receiving angles characterized by a wavelength-controlled angular tuning range within the first plane and a phase-shift-controlled angular tuning range within a plane perpendicular to the first plane; wherein at least two of the wavelength-controlled angular tuning ranges of the beams of the plurality of transmitting OPAs are at least partially non-overlapping and each of plurality of receiving OPAs has a wavelength-controlled angular tuning range that at least partially overlaps with a wavelength-controlled angular tuning range of at least one of the beams of the plurality of transmitting OPAs, or at least two of the phase-shift-controlled angular tuning ranges of the beams of the plurality of transmitting OPAs are at least partially non-overlapping and each of plurality of receiving OPAs has a phase-shift-controlled angular tuning range that at least partially overlaps with a phase-shift-controlled angular tuning range of at least one of the beams of the plurality of transmitting OPAs.

Aspects can have one or more of the following advantages.

The optical methods and systems disclosed herein can be used to emit or receive light beams, or probe and measure environments or regions, over a wide range of angles (i.e., a large field of view). The grating arrangements disclosed herein allow for angular offsets to be added along two dimensions of beam steering: the wavelength-controlled angular tuning range and the phase-shift-controlled angular tuning range. Such angular offsets allow for optical transceivers incorporating multiple optical phased arrays to cover a larger range of angles. Some grating arrangements allow for multiple beams to be transmitted by a single optical phased array, possibly reducing complexity, power consumption, size, and weight.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic diagram of an example optical phased array.

FIG. 2 is a schematic diagram of an example optical transceiver system.

FIG. 3A is a schematic diagram of an example optical transceiver system.

FIG. 3B is a schematic diagram of an example optical transceiver system.

FIG. 3C is a schematic diagram of an example optical transceiver system.

FIG. 3D is a schematic diagram of an example optical transceiver system and example fields of view for each optical phased array in the transceiver.

FIG. 3E is a schematic diagram of an example optical transceiver system and example fields of view for each optical phased array in the transceiver.

FIG. 3F is a schematic diagram of an example optical transceiver system.

FIG. 3G is a schematic diagram of an example optical transceiver system.

FIG. 4A is a schematic diagram of an example optical phased array.

FIG. 4B is a schematic diagram of an example grating antenna.

FIG. 4C is a prophetic plot of the square of the far-field electric field as a function of emission angle in four example optical phased arrays.

FIG. 4D is a schematic diagram of an example grating antenna.

FIG. 4E is a prophetic plot of the square of the far-field electric field as a function of emission angle for an example grating antenna.

FIG. 4F is a schematic diagram of an example grating antenna.

FIG. 4G is a prophetic plot of the square of the far-field electric field as a function of emission angle for an example grating antenna.

FIG. 4H is a schematic diagram of an example grating antenna.

FIG. 4I is a schematic diagram of an example arrangement of grating antennas.

FIG. 5A is a prophetic plot of light intensity as a function of angle in air for three corresponding example grating antennas, as well as schematic diagrams of the corresponding example grating antennas.

FIG. 5B is a schematic diagram of an example grating antenna.

FIG. 5C is a schematic diagram of an example grating antenna.

FIG. 5D is a schematic diagram of an example grating antenna.

FIG. 6A is a schematic diagram of an example grating antenna and a prophetic plot of a corresponding example far-field radiation pattern.

FIG. 6B is a schematic diagram of an example grating antenna and a prophetic plot of a corresponding example far-field radiation pattern.

FIG. 6C is a schematic diagram of an example arrangement of grating antennas.

FIG. 6D is a schematic diagram of an example arrangement of grating antennas.

FIG. 7A is a schematic diagram of an example grating antenna.

FIG. 7B is a schematic diagram of an example arrangement of grating antennas.

### DETAILED DESCRIPTION

Photonic integrated circuits (PICs) can enable beam steering, for example, by using optical phased arrays (OPAs). However, two-dimensional solid-state beam steering can be challenging for PIC-only architectures. In some examples, the second dimension of beam steering can be accessed by using wavelength tuning combined with grating-based antennas as the array of antennas within the OPA. For example, the grating-based antenna can be an optical grating antenna (or referred to herein as simply a “grating antenna”) in which there is a waveguide and grating elements distributed over at least a portion of the waveguide for perturbing the optical wave propagating in the waveguide, as described in more detail below.

Herein, techniques and devices comprising 2D-beam-steering are disclosed. In some examples, the disclosed techniques and devices can perform 2D-beam-steering that allows light emitted from one or more optical phased arrays to individually or collectively cover the volume of an entire hemisphere. In other examples, the 2D-beam-steering may cover a volume that is a portion of the volume of an entire hemisphere. For example, the 2D-beam-steering may cover a conical volume, or it may cover a portion of the volume of an entire hemisphere, wherein a spherical conical volume is removed from the hemisphere. Furthermore, the 2D-beam-steering may cover a portion of a spherical conical volume, wherein a smaller spherical conical volume is removed from the spherical conical volume. A spherical cone, also referred to as a spherical sector, is a portion of a sphere defined by a conical boundary with an apex (i.e., the point of the spherical cone) at the center of the sphere. A spherical cone is the union of a spherical cap and a cone formed by the center of the sphere and the base of the cap. The disclosed techniques and devices allow for an increased field of view accessible to light emitted or received from an optical phased array.

Some of the examples described herein comprise an optical phased array with a receiving aperture (i.e., a receiving optical phased array, a receiving portion, or receiving subsystem) and a transmitting aperture (i.e., a transmitting optical phased array, a transmitting portion, or a transmitting subsystem). Some examples can comprise separate structures (e.g., in bistatic arrangements), where the transmitting aperture and receiving aperture are not physically connected together, or are fabricated as stand-alone devices. In some examples, the transmitting aperture and the receiving aperture may be the same (e.g., in monostatic arrangements).

Herein, a range of angles may comprise both a wavelength-controlled angular tuning range within a first plane and a phase-shift-controlled angular tuning range within a plane perpendicular to the first plane.

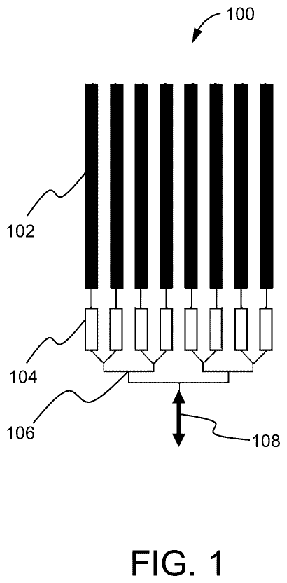

FIG. 1 shows an example optical phased array 100 comprising an array of grating antennas 102. Light can be transmitted from or received into grating elements (not shown) distributed over a line along which the grating antennas are arranged. The optical phased array 100 further comprises an array of phase shifters 104 which may be, for example, thermal phase shifters, electro-optical phase shifters, and/or microelectromechanical phase shifters. In some examples, each of the phase shifters 104 may be controlled independently, while in other examples two or more of the phase shifters 104 may be jointly controlled. The phase shifters 104 may modulate the direction and radiation intensity pattern (i.e., a gain pattern) associated with one or more beams transmitted from or received into the optical phased array 100. Optical power splitters 106 optically couple an optical port 108 to each of the phase shifters 104 which are optically coupled to respective grating antennas 102. In this example, the power splitters 106 are connected by waveguides in a binary tree arrangement, though in general, non-binary tree arrangements may be used. An optical wave received by the grating antennas 102 can thus be merged into an output optical wave at the optical port 108 which can then be further manipulated, transformed, or measured. In the reverse direction, an input optical wave provided at the optical port 108 can be coupled to and transmitted by the grating antennas 102 via grating elements (e.g., grating couplers).

In some implementations, the examples described herein may be designed to operate over a determined range of optical wavelengths, for example, the λ=1500 to 1600 nm band or the λ=1270 to 1330 nm band, and the base spacing pitch a between the grating antennas may be of similar magnitude to the optical wavelength. For example, for operation in the 1500 to 1600 nm band, 700 nm≤a≤4000 nm may be typical.

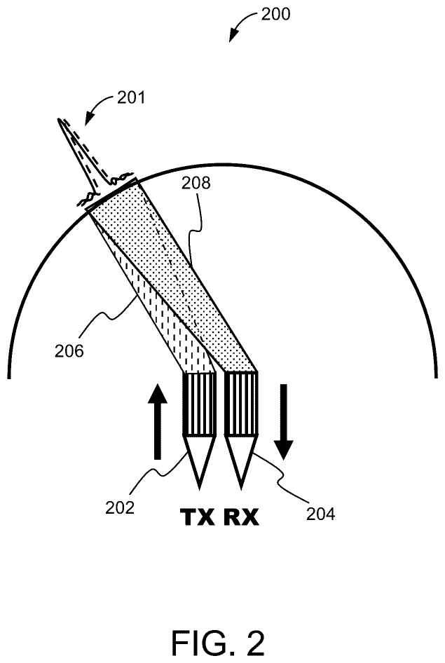

FIG. 2 shows an example optical transceiver system 200 comprising radiation intensity patterns 201 associated with a transmitter optical phased array 202 and a receiver optical phased array 204. A transmitter main lobe 206 and a receiver main lobe 208 overlap. Such an arrangement of lobe overlaps can result, for example, from tuning phase shifters associated with transmitter and receiving grating antennas in an optical phased array. In general, one or more optical beams emitted or received from an optical phased array within a transceiver system can be steered using reflective, dispersive, and/or refractive structures, for example. A return signal from an object situated near the main lobes is received by the receiver optical phased array 204.

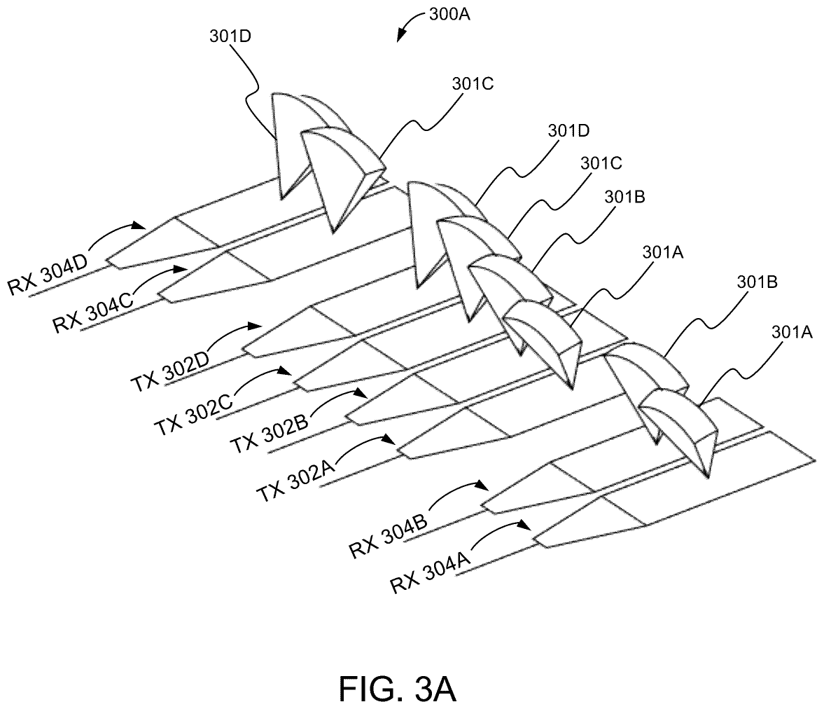

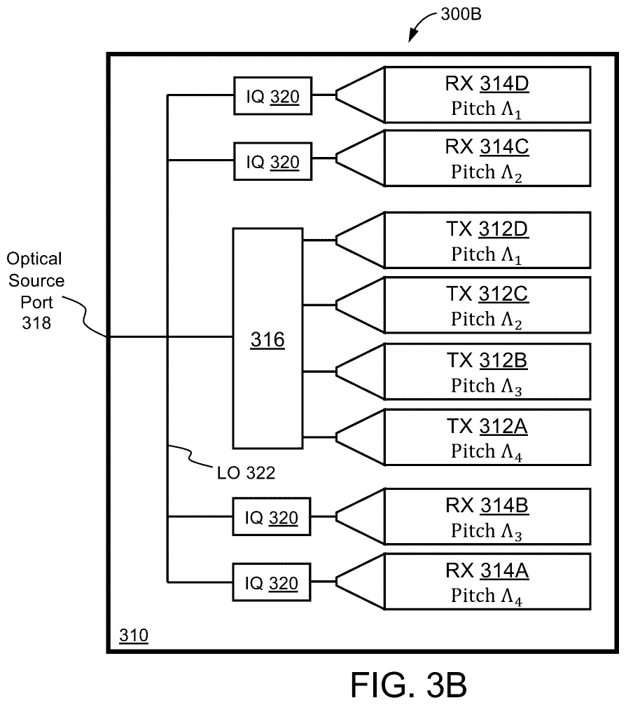

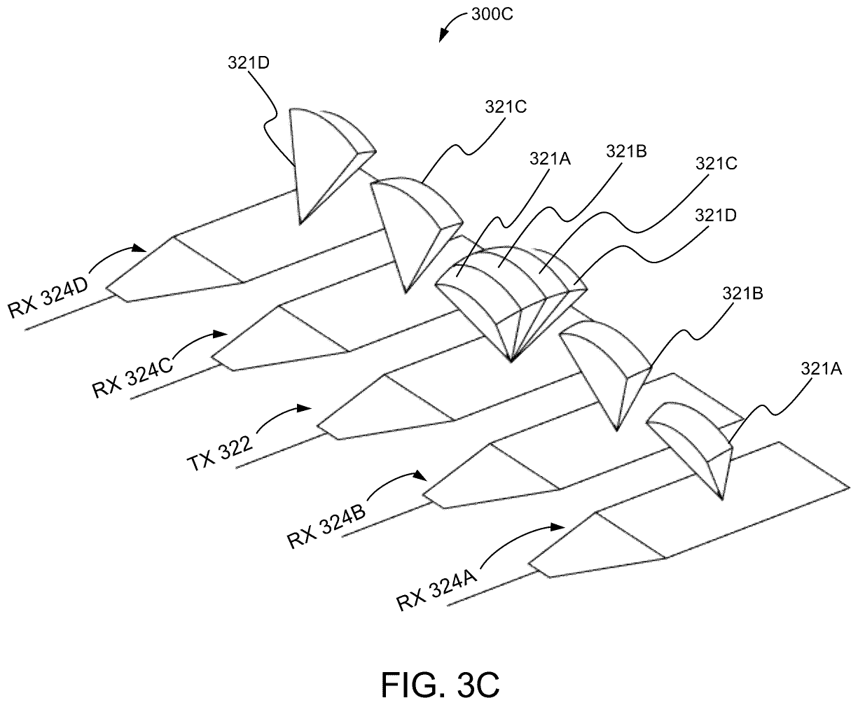

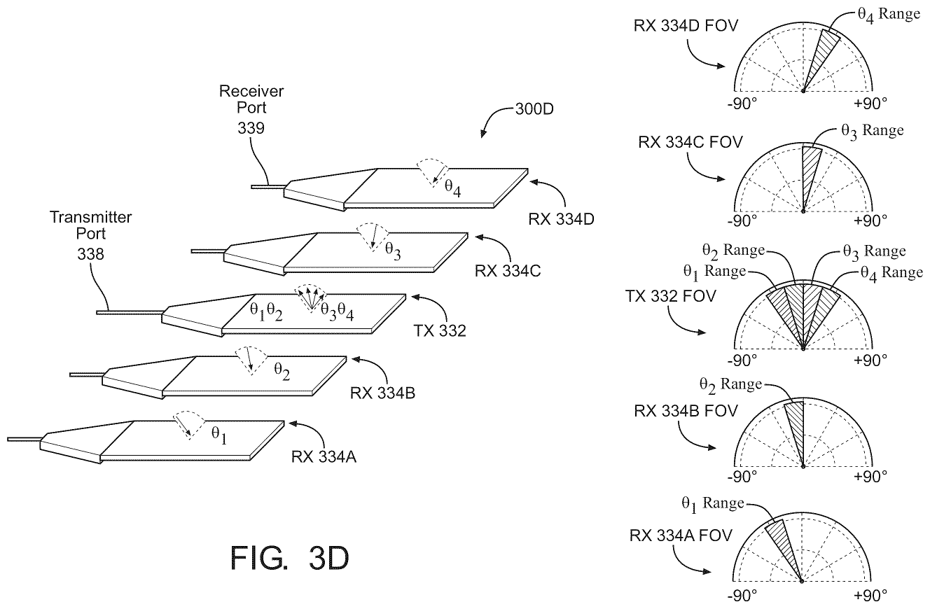

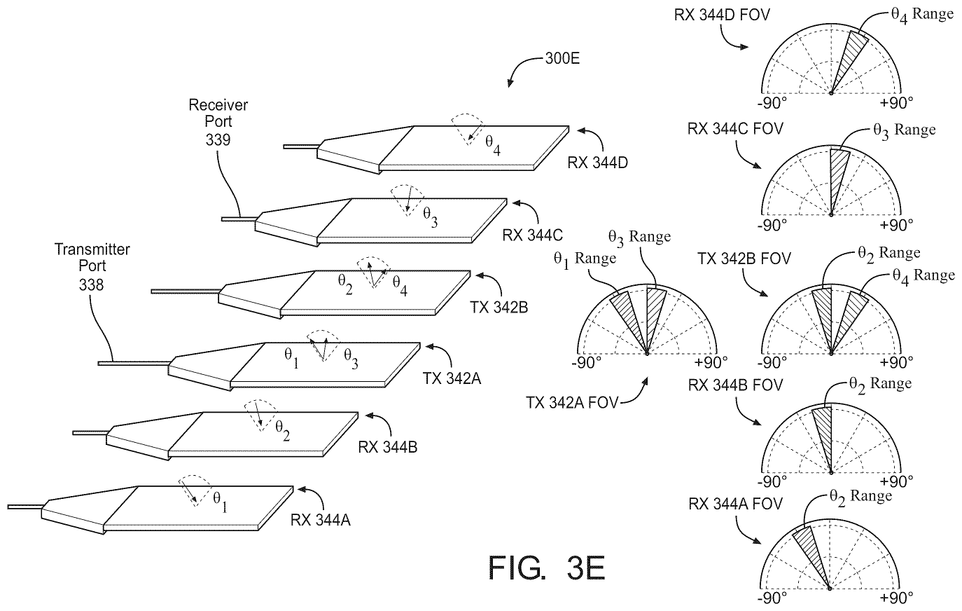

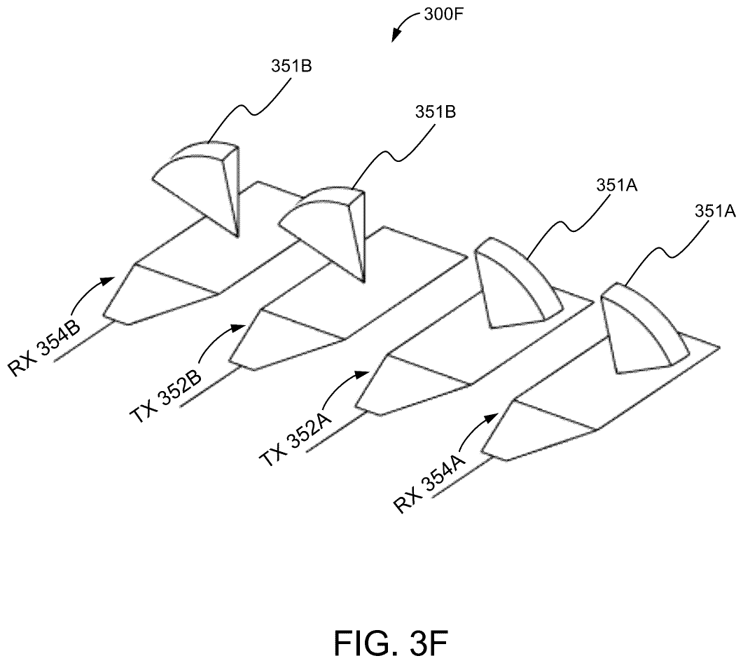

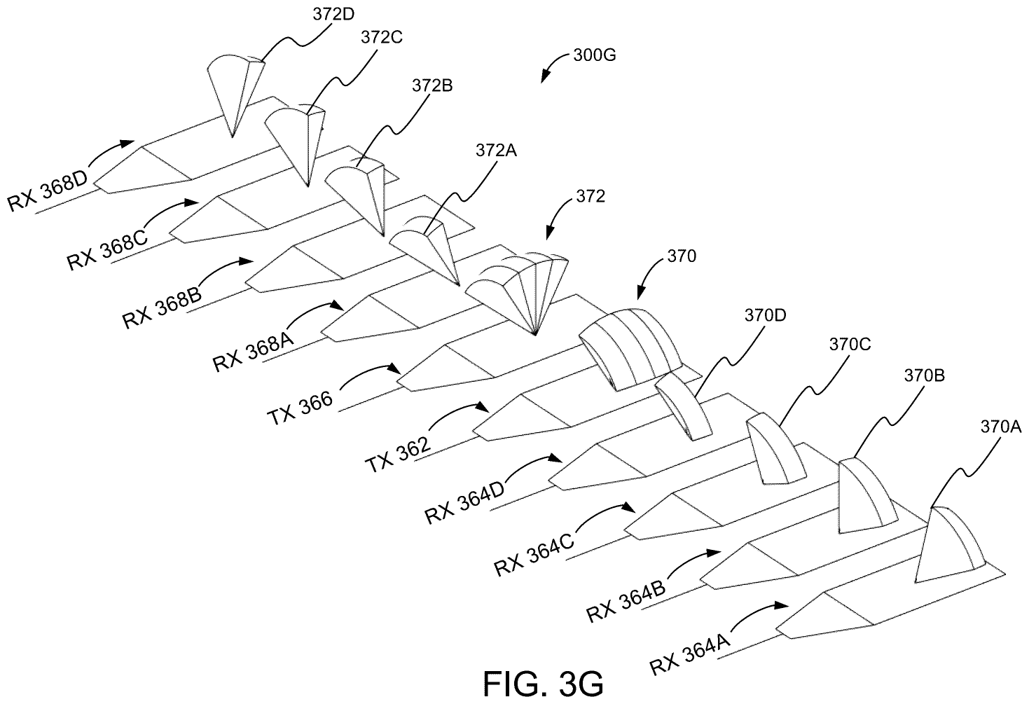

FIG. 3A shows an example optical transceiver system 300A comprising both transmitting (TX) optical phased arrays and receiving (RX) optical phased arrays configured to transmit or receive light over a tunable range of angles (e.g., using a wavelength-controlled angular tuning range that corresponds to a range of wavelengths over which an optical wave received from a coherent optical source, such as a tunable laser, has been tuned). In this example, there are four pairs of TX and RX optical phased arrays where, within each pair, the TX and RX optical phased arrays each have a tunable range of transmit or receive angles for beam-steering that are substantially similar. The four pairs of TX and RX optical phased arrays are (1) a first TX optical phased array 302A and a first RX optical phased array 304A, each with a first range of angles 301A, (2) a second TX optical phased array 302B and a second RX optical phased array 304B, each with a second range of angles 301B, (3) a third TX optical phased array 302C and a third RX optical phased array 304C, each with a third range of angles 301C, and (4) a fourth TX optical phased array 302D and a fourth RX optical phased array 304D, each with a fourth range of angles 301D. In some examples, different fields of view (e.g., corresponding to steering ranges for transmitted beams or different sets of angles being received) are at least partially non-overlapping. For example, each range of angles associated with an OPA cover a respective field of view, such that the four pairs of TX and RX optical phased arrays are able to transmit and receive light over a larger field of view collectively. In some examples, the fields of view may have small overlap, such that the collective field of view is substantially increased when compared to a singular field of view from one optical phased array. In other examples, the fields of view may have substantial overlap (e.g., to allow for redundancy of detection, or depending on the application). It is understood that light transmitted or received by an optical phased array can have angular intensity profiles with small but non-zero tails. Herein, partially overlapping fields of view is directed towards two or more fields of view that overlap in portions of the respective intensity profiles that are not in the (possibly rapidly) decaying tails of the intensity profile. In this example, the range of angles associated with each optical phased array is offset relative to at least one other optical phased array in the optical transceiver system 300A (e.g., by using a different pitch of grating elements, as shown in FIG. 3B). The angular offset is with respect to a wavelength-controlled angular tuning range within a first plane, while a phase-shift-controlled angular tuning range allows for additional tunability in a plane orthogonal to the first plane.

FIG. 3B shows an example optical transceiver system 300B comprising both TX optical phased arrays and RX optical phased arrays on a photonic chip 310 configured to transmit and/or receive light over a tunable range of angles. In this example, there are four pairs of TX and RX optical phased arrays where, within each pair, the TX and RX optical phased arrays each have a range of transmit or receive angles for beam-steering that are substantially similar, due in part to each TX and RX pair having substantially similar pitches Λ. The four pairs of TX and RX optical phased arrays are (1) a first TX optical phased array 312A and a first RX optical phased array 314A, each having pitch Λ₄, (2) a second TX optical phased array 312B and a second RX optical phased array 314B, each having pitch Λ₃, (3) a third TX optical phased array 312C and a third RX optical phased array 314C, each having pitch θ₂, and (4) a fourth TX optical phased array 312D and a fourth RX optical phased array 314D, each having pitch θ₁. The first TX optical phased array 312A, the second TX optical phased array 312B, the third TX optical phased array 312C, and the fourth TX optical phased array 312D are each optically coupled to an optical source port 318, by an optical splitter 316, such that the optical source port 318 provides an optical wave that can have a spectral peak wavelength that is tunable. The optical splitter 316 may selectively allow optical coupling between the optical source port 318 and the TX optical phased arrays (e.g., connecting only one of the TX optical phased arrays to the optical source port 318 at a time in sequence, or connecting all four TX optical phased arrays). The optical wave may be generated on the photonic chip 310 or optically coupled onto the photonic chip 310. The first RX optical phased array 314A, the second RX optical phased array 314B, the third RX optical phased array 314C, and the fourth RX optical phased array 314D are each optically coupled to respective IQ detectors 320 that are each optically coupled to respective LO signals 322 (local oscillator signals), which in this example are also derived from the optical wave provided at the optical source port 318. The IQ detectors 320 are an example of a coherent receiver which produces an in-phase signal and a quadrature-phase signal. Other examples of coherent receivers include a balanced detector. Within a coherent receiver there are two optical waves that are coherently mixed together. One of the optical waves is a local oscillator (LO), and the other optical wave may be a received optical signal (e.g., from the first RX optical phased array 314A) that may be scattered back (e.g., in a LiDAR application). In order to be coherently mixed, the LO and RX signals may be in substantially the same mode. A particular mode of the optical wave corresponds to a particular spatial mode and a particular temporal mode. The spatial mode may have a particular intensity distribution over a transverse plane that is perpendicular to the propagation axis of the optical wave. The temporal mode may depend on the basis that is used. For example, a particular temporal mode may be based on a particular longitudinal mode (with a particular wavelength) that is lasing within the laser system in continuous wave operation, or may be based on a particular temporal envelope that is lasing within the laser system in pulsed operation (e.g., in a mode locked laser). Therefore, a laser system (not shown) may be configured and calibrated to generate a single mode output to be used in such a coherent receiver to provide both the LO signal 322 (as an optical wave) and a transmitted optical wave at the optical source port 318 (e.g., in a LiDAR or communication application) which is then transmitted by one or more of the TX optical phased arrays and subsequently received by one or more of the RX optical phased arrays.

FIG. 3C shows an example optical transceiver system 300C comprising both TX optical phased arrays and RX optical phased arrays configured to transmit or receive light over a tunable range of angles. In this example, there is only one TX optical phased array 322 and four RX optical phased arrays. The TX optical phased array 322 has four beams (i.e., multimodal emission) each with respective tunable ranges over which it can transmit light: a first range of angles 321A, a second range of angles 321B, a third range of angles 321C, and a fourth range of angles 321D. A first RX optical phased array 324A is configured to receive light over the first range of angles 321A, a second RX optical phased array 324B is configured to receive light over the second range of angles 321B, a third RX optical phased array 324C is configured to receive light over the third range of angles 321C, and a fourth RX optical phased array 324D is configured to receive light over the fourth range of angles 321D. Thus, the TX optical phased array 322 is configured to emit light over four ranges of angles, while four RX optical phased arrays are each configured to receive light over a single range of angles that substantially overlap with at least one of the four ranges of angles of the TX optical phased array 322. In some applications, the four ranges of angles of the TX optical phased array 322 may not substantially overlap with one or more of the ranges of the four RX optical phased arrays. In some examples, RX optical phased arrays with multiple beam reception may be used, similar to the TX optical phased array 322. However, it may be difficult for such an optical transceiver to differentiate which of the multiple beams are being received by such an RX optical phased array. In such cases, the RX optical phased arrays shown in FIG. 3C can allow for differentiation of multiple beams by having a receiving angle that only substantially overlaps with one beam from the TX optical phased array 322.

FIG. 3D shows an example optical transceiver system 300D with example fields of view (FOV). In this example, there is only one TX optical phased array 332 and four RX optical phased arrays, each coupled to respective ports. The TX optical phased array 332 receives light to be transmitted from a transmitter port 338 (coupled to an optical source port, not shown), and the RX optical phased arrays provide light that has been received at a respective receiver port 339. The four RX optical phased arrays each have a FOV corresponding to a range of angles (e.g., a θ₁ range of angles for a first RX optical phased array 334A). The TX optical phased array 332 has four ranges of angles, each associated with a respective beam of light emitted by the TX optical phased array 332. For example, one beam of light emitted by the TX optical phased array 332 may have a θ₁ range of angles, a second beam of light may have a θ₂ range of angles, a third beam of light may have a θ₃ range of angles, and a fourth beam of light may have a θ₄ range of angles. The θ₁-θ₄ ranges of angles may be larger or smaller than those shown in this example, and additional or fewer beams of light may be emitted by the TX optical phased array 332.

FIG. 3E shows an example optical transceiver system 300E with example fields of view (FOV). In this example, there is a first TX optical phased array 342A, a second TX optical phased array 342B, and four RX optical phased arrays, each coupled to respective ports. The TX optical phased arrays receive light to be transmitted from a respective transmitter port 348 (coupled to an optical source port, not shown), and the RX optical phased arrays provide light that has been received at a respective receiver port 349. The four RX optical phased arrays each have a FOV corresponding to a range of angles (e.g., a θ₁ range of angles for a first RX optical phased array 344A). The first TX optical phased array 342A has two ranges of angles, each associated with a respective beam of light emitted by the first TX optical phased array 342A. For example, one beam of light emitted by the first TX optical phased array 342A may have a θ₁ range of angles and a second beam of light may have a θ₃ range of angles. The second TX optical phased array 342B also has two ranges of angles, each associated with a respective beam of light emitted by the second TX optical phased array 342B. For example, one beam of light emitted by the second TX optical phased array 342B may have a θ₂ range of angles and a second beam of light may have a θ₄ range of angles. The θ₁-θ₄ ranges of angles may be larger or smaller than those shown in this example, and additional or fewer beams of light may be emitted by the first TX optical phased array 342A or the second TX optical phased array 342B.

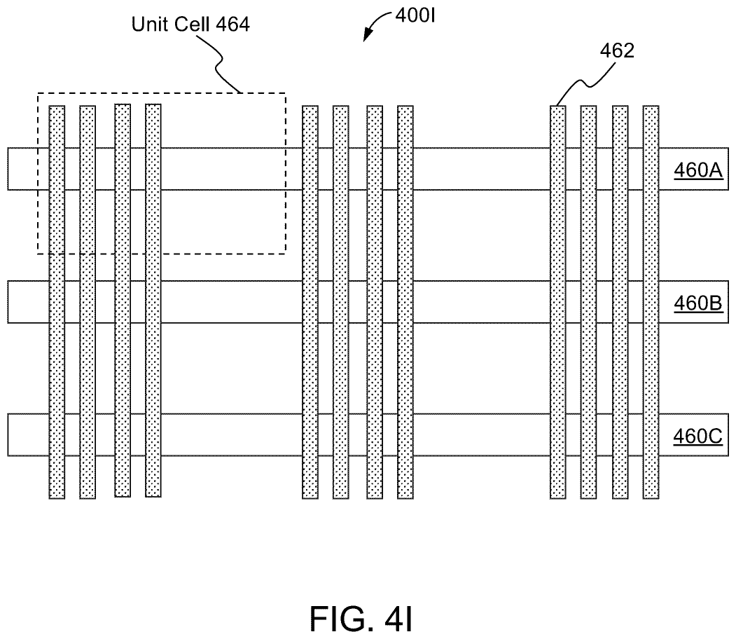

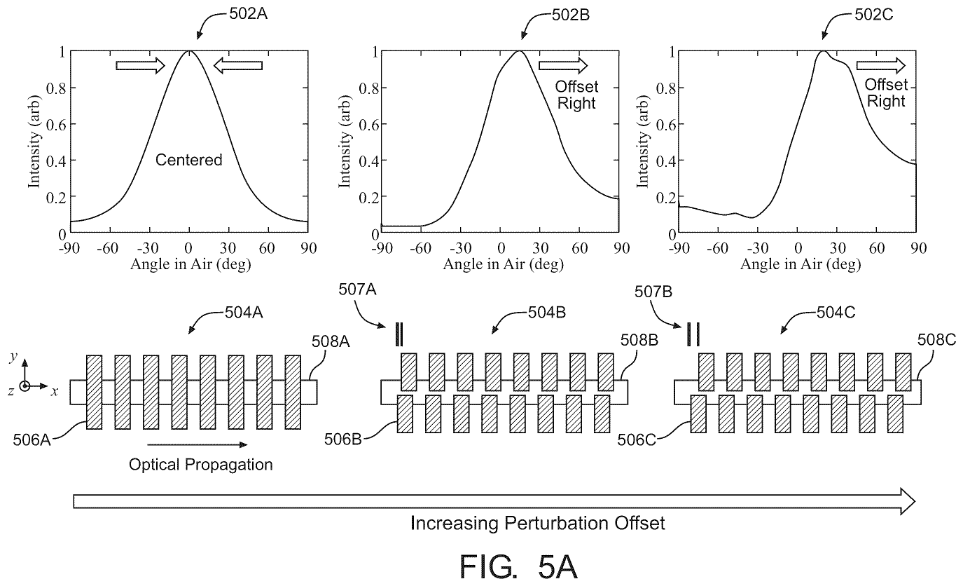

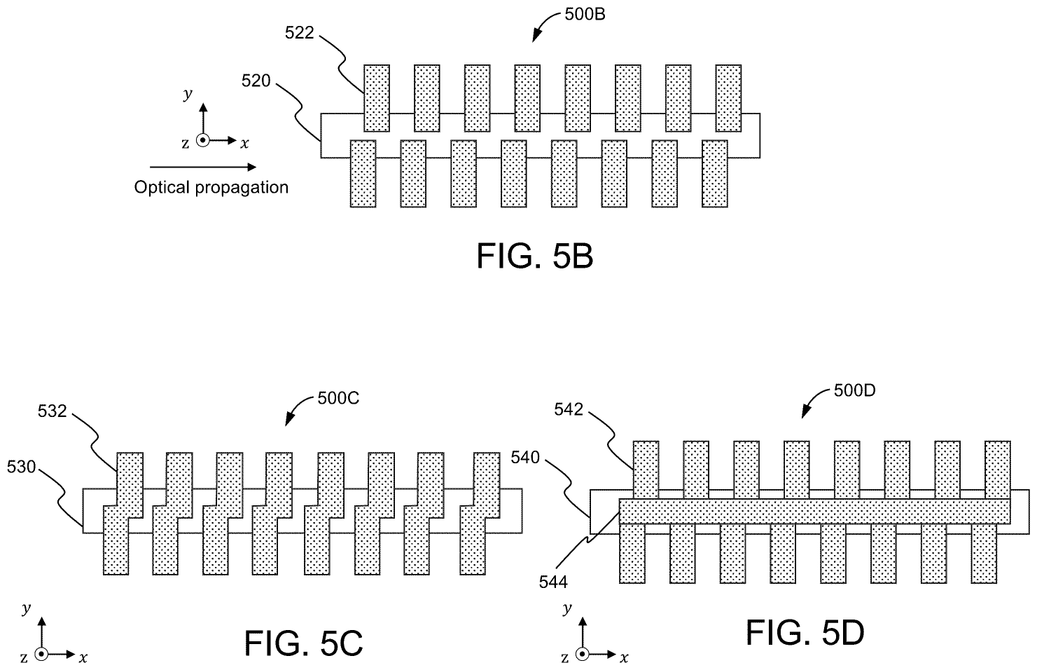

FIG. 3F shows an example optical transceiver system 300F. A first TX optical phased array 352A is configured to transmit light over a first range of angles 351A and a first RX optical phased array 354A is configured to receive light over the first range of angles 351A. Similarly, a second TX optical phased array 352B is configured to transmit light over a second range of angles 351B and a second RX optical phased array 354B is configured to receive light over the second range of angles 351B. In this example, the range of angles associated with each optical phased array is offset relative to at least one other optical phased array in the optical transceiver system 300F (e.g., by using grating elements arranged in two rows of the same pitch but offset from one another, as shown in FIGS. 5A-D). The angular offset is with respect to a phase-shift-controlled angular tuning range, which corresponds to a range of phase shifts imposed using the phase shifters of the OPAs, within a second plane, while a wavelength-controlled angular tuning range allows for additional tunability for beam steering orthogonal to the second plane.

In general, optical transceiver systems may designed to selectively incorporate elements from the optical transceiver systems of FIG. 3A, FIG. 3C, and FIG. 3E. For example, angular offsets with respect to both the wavelength-controlled angular tuning range and the phase-shift-controlled angular tuning range may allow for larger fields of view for an optical transceiver system comprising optical phased arrays with one or more such angular offsets.

FIG. 3G shows an example optical transceiver system 300G comprising both TX optical phased arrays and RX optical phased arrays configured to transmit or receive light over a tunable range of angles. A first TX optical phased array 362 transmits four beams (i.e., multimodal emission) each with respective tunable ranges. Collectively the four beams of the first TX optical phased array 362 can transmit light over a first collective range of angles 370 comprising a first range of angles 370A, a second range of angles 370B, a third range of angles 370C, and a fourth range of angles 370D. A first RX optical phased array 364A is configured to receive light over the first range of angles 370A, a second RX optical phased array 364B is configured to receive light over the second range of angles 370B, a third RX optical phased array 364C is configured to receive light over the third range of angles 370C, and a fourth RX optical phased array 364D is configured to receive light over the fourth range of angles 370D. A second TX optical phased array 366 transmits four beams (i.e., multimodal emission) each with respective tunable ranges. Collectively the four beams of the second TX optical phased array 366 can transmit light over a second collective range of angles 372 comprising a fifth range of angles 372A, a sixth range of angles 372B, a seventh range of angles 372C, and an eighth range of angles 372D. A fifth RX optical phased array 368A is configured to receive light over the fifth range of angles 372A, a sixth RX optical phased array 368B is configured to receive light over the sixth range of angles 372B, a seventh RX optical phased array 368C is configured to receive light over the seventh range of angles 372C, and an eighth RX optical phased array 368D is configured to receive light over the eighth range of angles 372D. In this example, the range of angles associated with each optical phased array is offset relative to at least one other optical phased array in the optical transceiver system 300G.

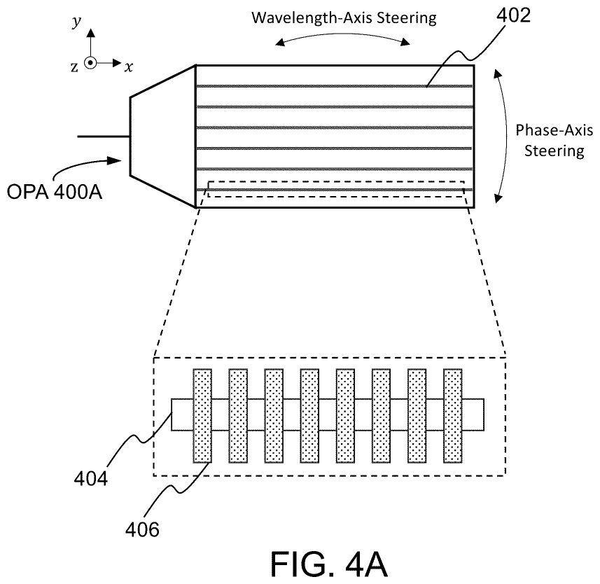

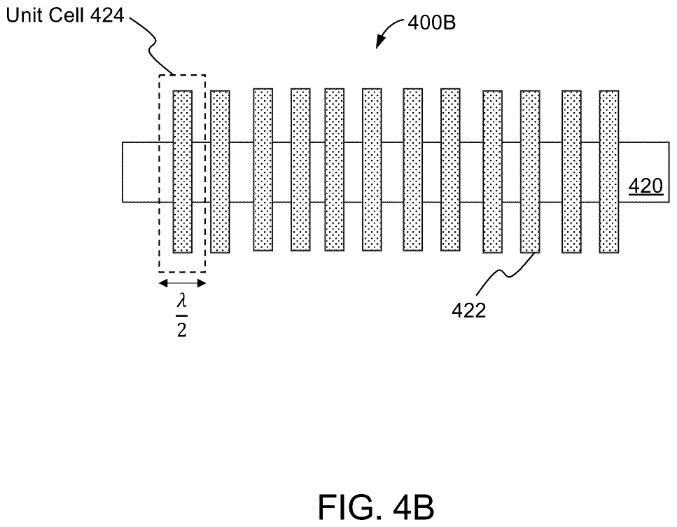

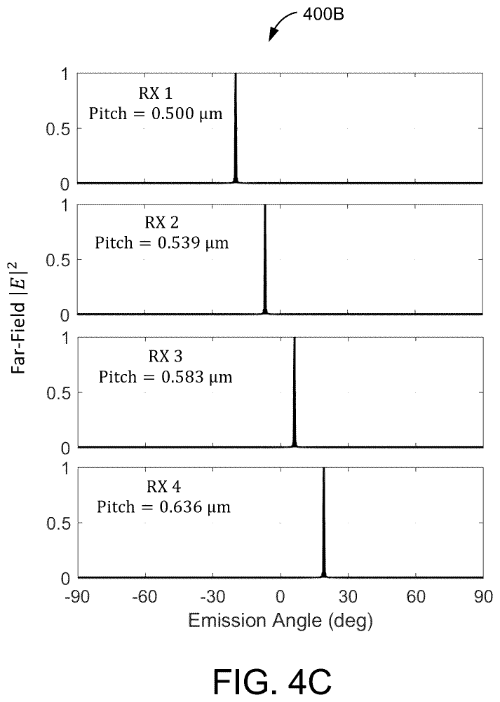

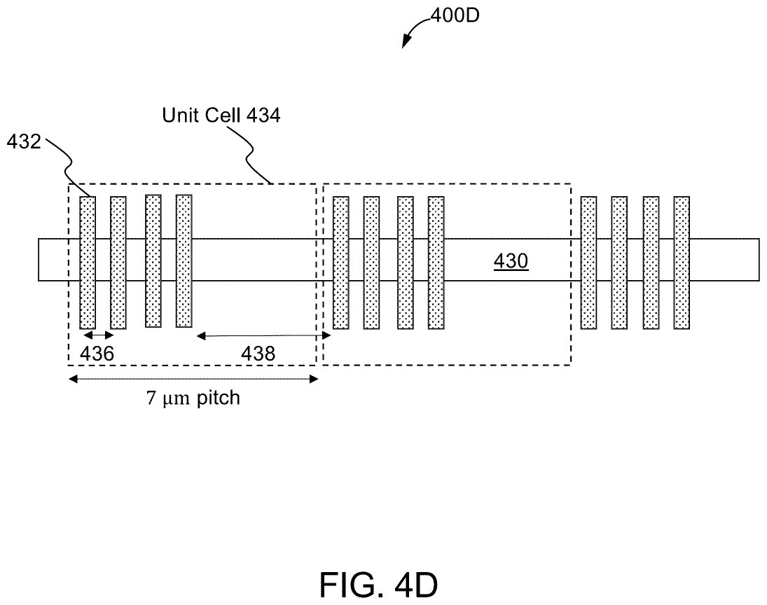

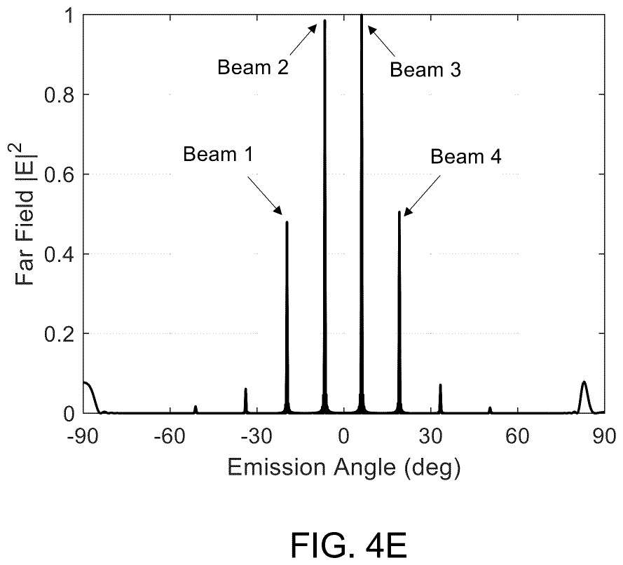

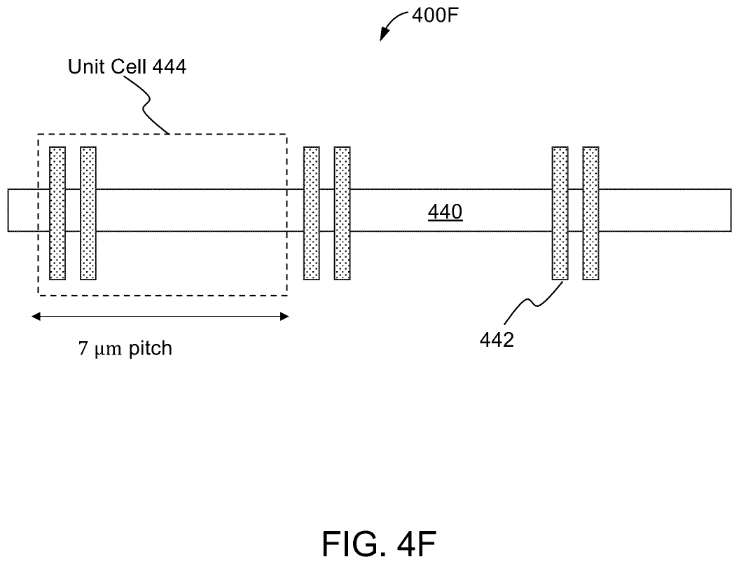

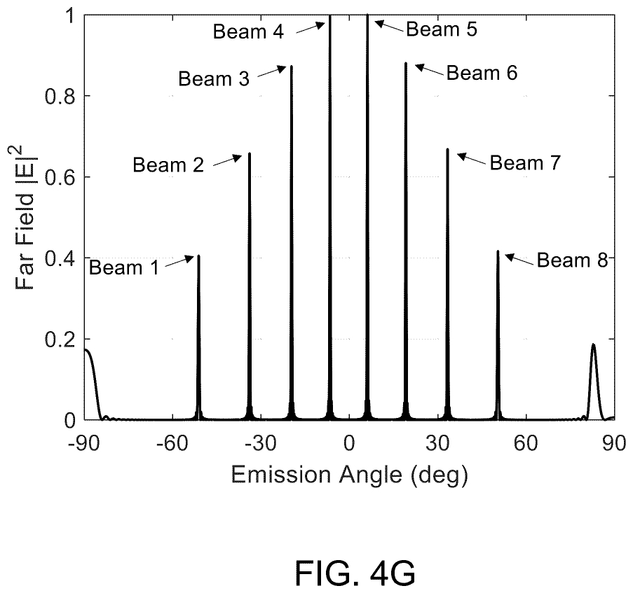

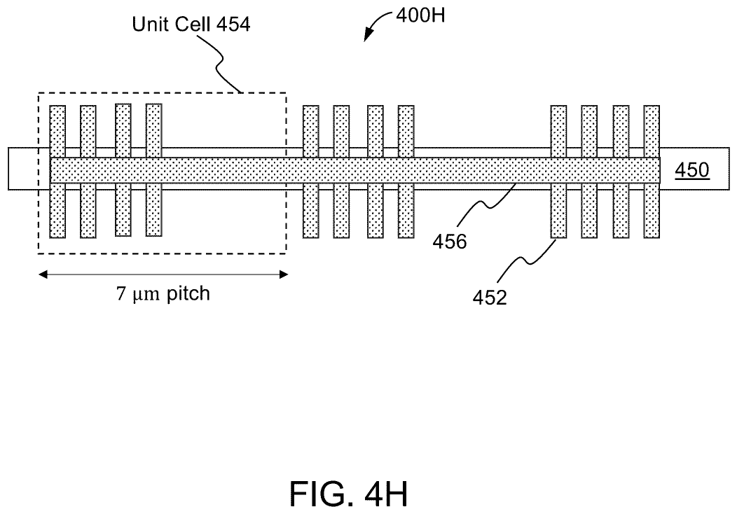

FIG. 4A shows an OPA 400A (optical phased array) comprising numerous grating antennas 402 that can transmit and receive light. Each grating antenna comprises a waveguide 404 and grating elements 406 arranged periodically with a constant pitch (i.e., a constant spacing between grating elements 406). The range of solid angles over which the OPA 400A can transmit and receive light can be modified about two orthogonal directions: (1) a wavelength-controlled angular tuning range to steer about the y-axis and enable scanning along the x-axis and (2) a phase-shift controlled angular tuning range to steer about the x-axis and enable scanning along the y-axis. Wavelength-controlled steering can be performed by modifying the wavelength of light transmitted or received by the OPA 400A, while phase-shift-controlled steering can be performed by changing the relative phase-shift between different grating antennas 402.

FIG. 4B shows a grating antenna 400B comprising a waveguide 420 and grating elements 422 (e.g., grating couplers) arranged periodically according to a unit cell 424 with a constant grating element pitch (i.e., a constant spacing between grating elements 422) that can be on the order of a wavelength of light, λ. A grating element pitch that is less than λ/2 results in a single tunable beam of light to be transmitted or received by an optical phased array (not shown) comprising such grating antennas.

FIG. 4C shows a prophetic plot of the square of the far-field electric field as a function of emission angle in four example RX optical phased arrays that have different grating element pitches associated with their grating antennas. As the grating element pitch is varied between 0.5-0.636 μm, the emission angle associated with a peak in the square of the far-field electric field correspondingly varies. Thus, by incorporating optical phased arrays with different grating element pitches into an optical transceiver, the optical transceiver can transmit and receive light over a wider range of angles, as shown in FIGS. 3A, 3B, 3C, and 3D.

FIG. 4D shows an example grating antenna 400D comprising a waveguide 430 and grating elements 432 arranged periodically according to a unit cell 434 with a non-constant grating element pitch (i.e., a non-constant spacing between grating elements 432 within a unit cell compared to grating elements 432 in neighboring unit cells). In this example, grating elements 432 within a unit cell 434 are separated by a distance 436 on the order of a wavelength of light, λ. The distance 438 between the last grating element within a unit cell and the first grating element within a subsequent unit cell, can be much larger than the grating distance 436 such that each unit cell 434 has a length of 7 μm. By designing the grating elements 432 in such a configuration, the grating antenna 400D can transmit and receive multiple beams of light at different angles, as shown in FIG. 4E. In general, the length of the unit cell can vary depending on the application. In some examples, the length of the unit cell is substantially larger than the wavelength of the light being transmitted or received. The length of the unit cell 434 determines the number of beams appearing in the array factor, and the arrangement of perturbations (e.g., grating elements 432) within the unit cell 434 determines the overall envelope (i.e., element factor) that sets the relative strengths of the different beams. In general, larger unit cell lengths produce an array factor with more beams since the beam spacing may be inversely proportional to the unit cell spacing. Additional changes within each unit cell 434 (e.g., shorter or longer arrangements of grating elements, resulting in fewer or more grating elements) produce a wider or narrower element factor, respectively, based on the resulting intensity shaping (i.e., envelope) that is applied (i.e., multiplied) to those beams. Other changes within and/or among unit cells can be made to achieve different beam characteristics, such as different relative strengths of different beams.

FIG. 4E shows a prophetic plot of the square of the far-field electric field as a function of emission angle for an example grating antenna with a non-constant grating element pitch (e.g., the grating antenna 400D in FIG. 4D). The multiple peaks in the far-field electric field show that at least eight beams of light at different emission angles may be transmitted and received by such a grating antenna. The peaks shown may further be tuned by modifying the wavelength of the light being transmitted or received.

FIG. 4F shows an example grating antenna 400F comprising a waveguide 440 and grating elements 442 arranged periodically according to a unit cell 444 with a non-constant grating element pitch (i.e., a non-constant spacing between grating elements 442 within a unit cell compared to grating elements 442 in neighboring unit cells). In this example, some grating elements 442 are separated by a distance on the order of a wavelength of light, λ, while some grating elements 442 are separated by larger distances. For example, in this example each unit cell has a length of 7 μm. By arranging the grating elements 442 in such a configuration, the grating antenna 400F can emit and receive multiple beams of light at different angles. Compared to the grating antenna 400D in FIG. 4D, the grating antenna 400F in FIG. 4F has fewer grating elements 442 per unit cell 444.

FIG. 4G shows a prophetic plot of the square of the far-field electric field as a function of emission angle for an example grating antenna with a non-constant grating element pitch (e.g., the grating antenna 400F in FIG. 4F). The multiple peaks in the far-field electric field show that at least eight beams of light at different emission angles may be transmitted or received by such a grating antenna. FIG. 4G and FIG. 4E both show prophetic plots for grating antennas with unit cell lengths of 7 μm, thus they both show the same number of beams emitted (i.e., eight peaks in the far-field electric field). However, the grating antenna corresponding to FIG. 4G contains fewer perturbations within each unit cell, resulting in a broader element factor (i.e., envelope) that is applied (i.e., multiplied) to those eight beams.

FIG. 4H shows an example grating antenna 400H comprising a waveguide 450 and grating elements 452 arranged periodically according to a unit cell 454 with a non-constant grating element pitch (i.e., a non-constant spacing between grating elements 452 within a unit cell compared to grating elements 452 in neighboring unit cells). In this example, the grating elements 452 are interconnected by a strip 456 made of the same material as the grating elements 452 (e.g., silicon nitride) and parallel to the propagation axis of the waveguide 450. In other examples, the strip 456 may be of a different material, but may have substantially the same index of refraction as the grating elements 452. The inclusion of such a strip may simplify fabrication of grating antennas. Furthermore, the strip 456 can be designed such that the range of angles over which light is emitted from a TX optical phased array comprising numerous grating antennas 400H can better match the range of angles over which light is received from an RX optical phased array comprising grating antennas that have a constant, subwavelength pitch between grating antennas. The range of angles may not match due to mismatches in the index of refraction between the TX and RX optical phased arrays. For example, a grating antenna with separations between grating elements larger than a wavelength and that does not comprise a strip (e.g., 400F in FIG. 4F) may have an index of refraction substantially different from an RX optical phased array comprising grating antennas that have a constant, subwavelength pitch between grating antennas. The difference in index of refraction may result due to the difference in the amount of grating material (e.g., silicon nitride) on a surface of the waveguide. Thus, by incorporating the strip 456, the index of refraction on a surface of the waveguide 450 can be designed to better match an RX optical phased array.

FIG. 4I shows an example arrangement of grating antennas 400I comprising a first waveguide 460A, a second waveguide 460B, a third waveguide 460C, and grating elements 462 arranged periodically according to a unit cell 464 with a non-constant grating element pitch (i.e., a non-constant spacing between grating elements 462). In this example, the three waveguides are interconnected by grating elements 462 that span over the distance separating the waveguides. Such a design can simplify fabrication and may result in faster throughput for manufacture and higher consistency of optical transmission and reception due to better control over relative positioning of grating elements across two or more grating antennas.

In some examples, an optical transceiver system may have one or more RX optical phased arrays with a grating element pitch for each uniquely angled beam emitted by a grating antenna with a non-constant grating element pitch. Such a transceiver may then have a large field of view for both transmitting and receiving.

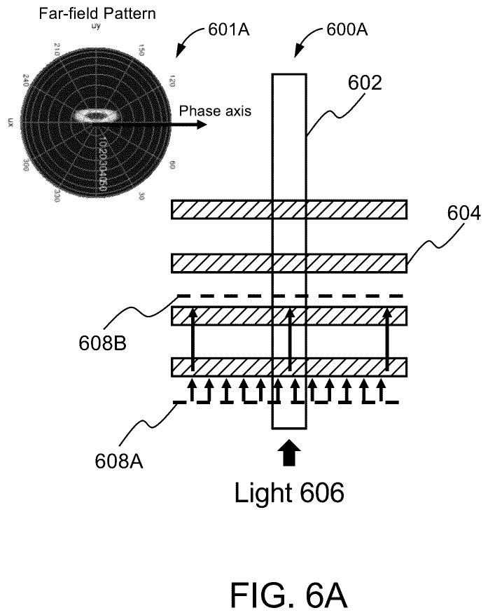

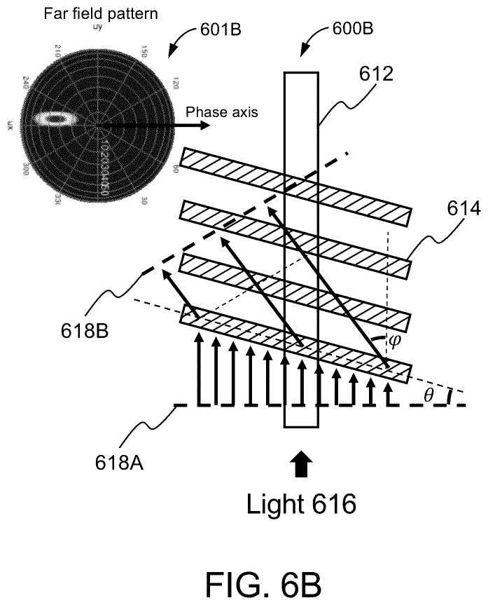

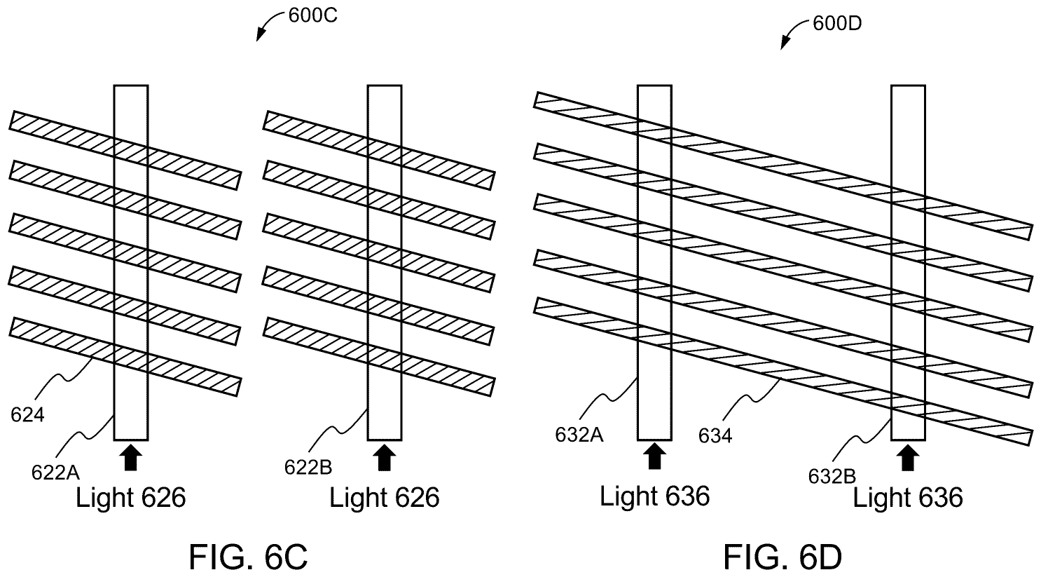

FIG. 5A shows three example prophetic plots (502A, 502B, and 502C) of light intensity as a function of angle in air for three corresponding grating antennas (504A, 504B, and 504C) with differing grating element (506A, 506B, and 506C) arrangements optically coupled to respective waveguides (508A, 508B, and 508C). Optical waves propagate along the x-axis through waveguides 508A, 508B, and 508C. In the first grating antenna 504A, grating elements 506A are arranged in a single row and each grating element extends in a direction that is perpendicular to the propagation axis, in this example parallel to the y-axis. In the second grating antenna 504B, grating elements 506B are arranged in two disconnected rows of the same pitch but with different portions of a grating element offset from one another by a first offset 507A. In the third grating antenna 504C, grating elements 506C are arranged in two disconnected rows of the same pitch but with different grating element portions further offset from one another relative to the offset of the second grating antenna 504B by a second offset 507B that, in this example, is larger than the first offset 507A. In such a configuration, an optical wave traveling along the propagation axis through grating antennas 504B and 504C is perturbed by a first portion of a grating element and then perturbed by a second offset portion of the grating element. Optical antennas that are capable of this perturbation are also demonstrated in FIGS. 5B, 5C, 5D, and 6B. The first prophetic plot 502A, corresponding to the first grating antenna 504A, shows a centered emission pattern. The second prophetic plot 502B, corresponding to the second grating antenna 504B, shows an angularly offset emission pattern. The third prophetic plot 502C, corresponding to the third grating antenna 504C, shows a further angular offset emission pattern relative to the second prophetic plot 502B. Thus, by increasing the offset between two rows of grating elements, the emission pattern can be further angularly offset. In some examples, more than two rows of grating elements may be used. In other examples, the grating elements can form two connected rows of the same pitch but offset from one another, as shown in FIG. 5C. In other examples, the grating elements may form one row that is non-orthogonal (i.e., at an angle) relative to the propagation axis of the waveguide along which they reside, as shown in FIG. 6B. By arranging grating elements such that a flat wavefront is perturbed (i.e., phase-shifted) at different locations along the propagation axis, an optical wave within the waveguide can have an angularly offset emission pattern. Furthermore, non-flat wavefronts can also be accounted for in the grating element arrangements to apply desired angular offsets.

FIG. 5B shows an example grating antenna 500B comprising a waveguide 520 and grating elements 522 optically coupled to the waveguide 520. Along a direction parallel to the propagation axis of the waveguide 520, in this example along the x-axis, the grating elements 522 are arranged into two disconnected rows of the same pitch but with different grating element portions offset from one another.

FIG. 5C shows an example grating antenna 500C comprising a waveguide 530 and grating elements 532 optically coupled to the waveguide 530. Along a direction parallel to the propagation axis of the waveguide 530, the grating elements 532 are arranged into two connected rows of the same pitch but with different grating element portions offset from one another.

FIG. 5D shows an example grating antenna 500D comprising a waveguide 540 and grating elements 542 optically coupled to the waveguide 540. Along a direction parallel to the propagation axis of the waveguide 540, the grating elements 542 are arranged into two rows of the same pitch, but offset from one another, wherein the two rows are connected by a strip 544 parallel to the propagation axis of the waveguide 540.

FIG. 6A shows an example grating antenna 600A and a prophetic plot of a corresponding example far-field radiation pattern 601A. The grating antenna 600A comprises a waveguide 602 and grating elements 604 arranged orthogonal to the propagation axis of the waveguide 602. Thus, light 606 with a flat first wavefront 608A will not have an angular deflection and will remain flat after propagating through the grating elements 604, resulting in a flat second wavefront 608B. The far-field radiation pattern 601A is substantially centered about 0 degrees on the phase-axis.

FIG. 6B shows an example grating antenna 600B and a prophetic plot of a corresponding example far-field radiation pattern 601B. The grating antenna 600B comprises a waveguide 612 and grating elements 614 arranged non-orthogonal to the propagation axis of the waveguide 612. Thus, light 616 with a flat first wavefront 618A will have different connected portions of one of the grating elements 614 perturb different portions of the wavefront 618A at different locations along the propagation axis, and will have an angular deflection of Ø and will remain flat after propagating through the grating elements 614, resulting in a flat second wavefront 618B propagating at a non-zero angle with respect to the phase-axis. The far-field radiation pattern 601B is thus substantially displaced from the center (0 degrees) of the phase-axis.

FIG. 6C shows an example arrangement of grating antennas 600C comprising a first waveguide 622A, a second waveguide 622B, and individual grating elements 624 arranged non-orthogonal to the propagation axis of each waveguide. Thus, light 626 with a flat first wavefront will have an angular deflection.

FIG. 6D shows an example arrangement of grating antennas 600D comprising a first waveguide 632A, a second waveguide 632B, and grating elements 634 arranged non-orthogonal to the propagation axis of each waveguide and that span both waveguides. Thus, light 636 with a flat first wavefront will have an angular deflection.

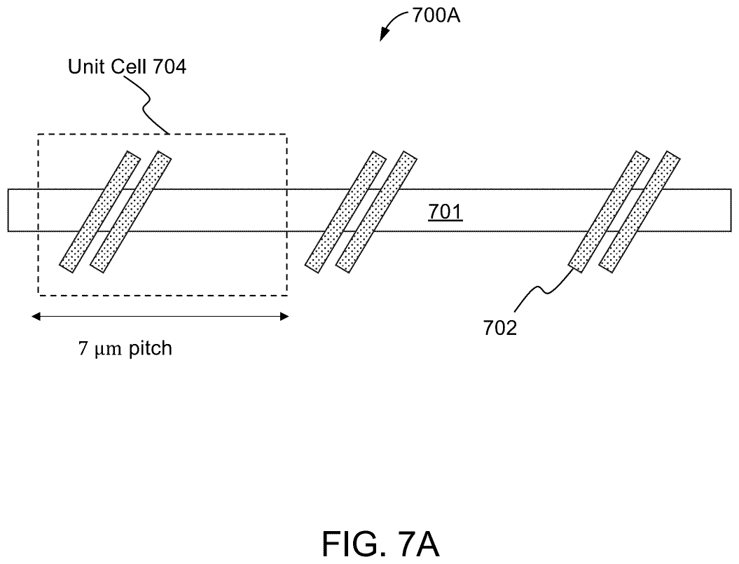

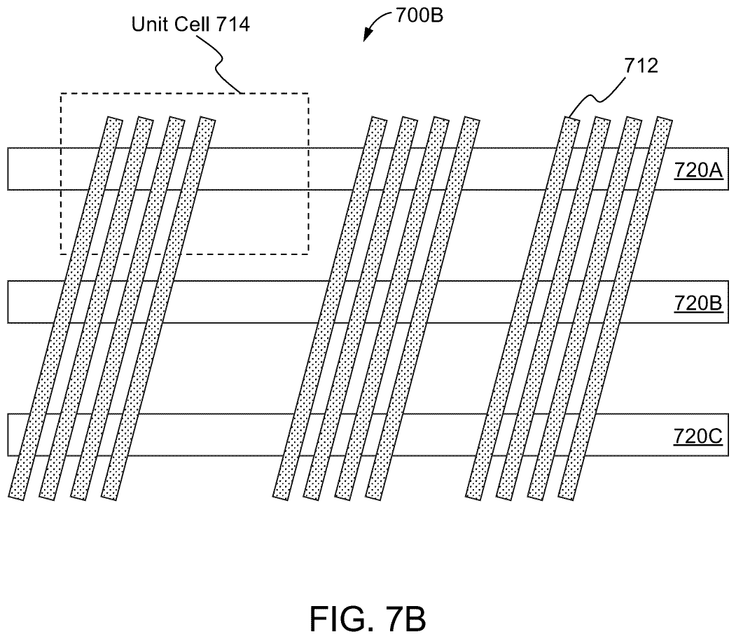

FIG. 7A shows an example arrangement of a grating antenna 700A that combines several features previously described in FIGS. 4F, 4I, 6C, and 6D. Grating antenna 700A comprises a waveguide 701 and grating elements 702 arranged periodically according to a unit cell 704 with a non-constant grating element pitch (i.e., a non-constant spacing between grating elements 702 within a unit cell compared to grating elements 702 in neighboring unit cells). In this example, some grating elements 702 are separated by a distance on the order of a wavelength of light, λ, while some grating elements 702 are separated by larger distances, such that the unit cell 704 has a length of 7 μm. By arranging the grating elements 702 in such a configuration, the grating antenna 700A can emit and receive multiple beams of light about two perpendicular axes. Compared to the grating antenna 400D in FIG. 4D, the grating antenna 700A in FIG. 7A has grating elements that are arranged non-orthogonal to the propagation axis of the waveguide 701.

FIG. 7B shows an example arrangement of grating antennas 700B comprising a first waveguide 720A, a second waveguide 720B, and a third waveguide 720C, and grating elements 712 that are arranged non-orthogonal to the propagation axis of each waveguide and that span all waveguides. The grating elements 712 are arranged periodically according to a unit cell 714 with a non-constant grating element pitch (i.e., a non-constant spacing between grating elements 712 within a unit cell compared to grating elements 712 in neighboring unit cells). Similar to the grating antenna 400I depicted in FIG. 4I, such a design can simplify fabrication and may result in faster throughput for manufacture and higher consistency of optical transmission and reception due to better control over relative positioning of grating elements across two or more grating antennas.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus comprising:
at least one optical source port providing an optical wave having a spectral peak wavelength that is tunable;
one or more transmitting optical phased arrays (OPAs), each transmitting OPA of the one or more transmitting OPAs:
being coupled to the optical source port, and
comprising a plurality of optical phase shifters that are tunable, and a plurality of optical grating antennas, including two or more optical grating antennas each coupled to a different respective one of the optical phase shifters,
wherein the one or more transmitting OPAs are configured to form a plurality of beams each characterized by a wavelength-controlled angular tuning range within a first plane and a phase-shift-controlled angular tuning range within a plane perpendicular to the first plane; and
a plurality of receiving OPAs, each receiving OPA of the plurality of receiving OPAs:
being coupled to a coherent receiver that is coupled to the optical source port,
comprising a plurality of optical phase shifters that are tunable, and a plurality of optical grating antennas, including two or more optical grating antennas each coupled to a different respective one of the optical phase shifters, and
being configured to receive optical waves from a set of receiving angles characterized by a wavelength-controlled angular tuning range within the first plane and a phase-shift-controlled angular tuning range within a plane perpendicular to the first plane;
wherein at least two of the wavelength-controlled angular tuning ranges of the plurality of beams are at least partially non-overlapping, and each of the wavelength-controlled angular tuning ranges of the plurality of receiving OPAs at least partially overlaps with at least one of the wavelength-controlled angular tuning ranges of the plurality of beams.

2. The apparatus of claim 1, wherein the one or more transmitting OPAs comprise a plurality of transmitting OPAs, and each transmitting OPA of the plurality of transmitting OPAs is configured to form a different one of the plurality of beams.

3. The apparatus of claim 1, wherein at least one of the one or more transmitting OPAs comprises:
at least one waveguide configured to guide an optical wave along a propagation axis;
a plurality of sets of grating elements distributed along the waveguide and configured to perturb a portion of the optical wave as it propagates along the waveguide to emit a plurality of beams at different respective angles about an axis that is perpendicular to the propagation axis, the plurality of sets of grating elements comprising:
a first set of grating elements with adjacent grating elements separated from each other along the propagation axis by a first length, and
a second set of grating elements with adjacent grating elements separated from each other along the propagation axis by the first length, where the second set of grating elements is separated from the first set of grating elements along the propagation axis by a gap without any grating elements at least twice as large as the first length.

4. The apparatus of claim 3, wherein each grating element of the plurality of sets of grating elements is in contact with a strip of material having substantially the same index of refraction as the grating elements.

5. The apparatus of claim 3, wherein the one or more transmitting OPAs consist of a single transmitting OPA configured to form the plurality of beams.

6. The apparatus of claim 3, wherein each grating element of the plurality of sets of grating elements extends along a direction substantially perpendicular to the propagation axis.

7. The apparatus of claim 3, wherein each grating element of the plurality of sets of grating elements comprises:
a first portion positioned to perturb a first portion of a wavefront of the optical wave at a first location along the propagation axis, and
a second portion positioned to perturb a second portion of the wavefront at a second location along the propagation axis different from the first location, where the second portion of the wavefront is at least partially non-overlapping with the first portion of the wavefront.

8. A method for managing optical phased array beam steering, the method comprising:
providing, from at least one optical source port, an optical wave having a spectral peak wavelength that is tunable;
transmitting a plurality of beams from one or more transmitting optical phased arrays (OPAs), each transmitting OPA of the one or more transmitting OPAs:
being coupled to the optical source port, and
comprising a plurality of optical phase shifters that are tunable, and a plurality of optical grating antennas, including two or more optical grating antennas each coupled to a different respective one of the optical phase shifters,
wherein the one or more transmitting OPAs are configured to form the plurality of beams each characterized by a wavelength-controlled angular tuning range within a first plane and a phase-shift-controlled angular tuning range within a plane perpendicular to the first plane; and
receiving optical waves into a plurality of receiving OPAs, each receiving OPA of the plurality of receiving OPAs:
being coupled to a coherent receiver that is coupled to the optical source port,
comprising a plurality of optical phase shifters that are tunable, and a plurality of optical grating antennas, including two or more optical grating antennas each coupled to a different respective one of the optical phase shifters, and
being configured to receive optical waves from a set of receiving angles characterized by a wavelength-controlled angular tuning range within the first plane and a phase-shift-controlled angular tuning range within a plane perpendicular to the first plane;
wherein at least two of the wavelength-controlled angular tuning ranges of the plurality of beams are at least partially non-overlapping, and each of the wavelength-controlled angular tuning ranges of the plurality of receiving OPAs at least partially overlaps with at least one of the wavelength-controlled angular tuning ranges of the plurality of beams.

9. An apparatus comprising:
at least one waveguide configured to guide an optical wave along a propagation axis; and
a plurality of sets of grating elements distributed along the waveguide and configured to perturb a portion of the optical wave as it propagates along the waveguide to emit a plurality of beams at different respective angles about an axis that is perpendicular to the propagation axis, the plurality of sets of grating elements comprising:
a first set of grating elements with adjacent grating elements separated from each other along the propagation axis by a first length, and
a second set of grating elements with adjacent grating elements separated from each other along the propagation axis by the first length, where the second set of grating elements is separated from the first set of grating elements along the propagation axis by a gap without any grating elements at least twice as large as the first length.

10. The apparatus of claim 9, further comprising:
at least one optical source port providing an optical wave having a spectral peak wavelength that is tunable;
a transmitting optical phased array (OPA):
being coupled to the optical source port, and
comprising a plurality of optical phase shifters that are tunable, and a plurality of optical grating antennas, including two or more optical grating antennas each coupled to a different respective one of the optical phase shifters, each of the optical grating antennas comprising a structure substantially identical to the waveguide and the plurality of sets of grating elements, and
being configured to form a plurality of beams each characterized by a wavelength-controlled angular tuning range within a first plane and a phase-shift-controlled angular tuning range within a plane perpendicular to the first plane; and
a plurality of receiving OPAs, each receiving OPA of the plurality of receiving OPAs:
being coupled to a coherent receiver that is coupled to the optical source port,
comprising a plurality of optical phase shifters that are tunable, and a plurality of optical grating antennas, including two or more optical grating antennas each coupled to a different respective one of the optical phase shifters, and
being configured to receive optical waves from a set of receiving angles characterized by a wavelength-controlled angular tuning range within the first plane and a phase-shift-controlled angular tuning range within a plane perpendicular to the first plane.

11. The apparatus of claim 10, wherein at least two of the wavelength-controlled angular tuning ranges of the plurality of beams are at least partially non-overlapping, and each of the wavelength-controlled angular tuning ranges of the plurality of receiving OPAs at least partially overlaps with at least one of the wavelength-controlled angular tuning ranges of the plurality of beams.

12. The apparatus of claim 9, wherein each grating element of the plurality of sets of grating elements is in contact with a strip of material having substantially the same index of refraction as the grating elements.

13. The apparatus of claim 9, wherein each grating element of the plurality of sets of grating elements comprises:
a first portion positioned to perturb a first portion of a wavefront of the optical wave at a first location along the propagation axis, and
a second portion positioned to perturb a second portion of the wavefront at a second location along the propagation axis different from the first location, where the second portion of the wavefront is at least partially non-overlapping with the first portion of the wavefront.

14. A method for fabricating an optical device, the method comprising:
forming at least one waveguide configured to guide an optical wave along a propagation axis; and
forming a plurality of sets of grating elements distributed along the waveguide and configured to perturb a portion of the optical wave as it propagates along the waveguide to emit a plurality of beams at different respective angles about an axis that is perpendicular to the propagation axis, the plurality of sets of grating elements comprising:
a first set of grating elements with adjacent grating elements separated from each other along the propagation axis by a first length, and
a second set of grating elements with adjacent grating elements separated from each other along the propagation axis by the first length, where the second set of grating elements is separated from the first set of grating elements along the propagation axis by a gap without any grating elements at least twice as large as the first length.

15. An apparatus comprising:
at least one waveguide configured to guide an optical wave along a propagation axis; and
a plurality of grating elements distributed along the waveguide and configured to perturb a portion of the optical wave as it propagates along the waveguide, each of the plurality of grating elements comprising:
a first portion positioned to perturb a first portion of a wavefront of the optical wave at a first location along the propagation axis, and
a second portion positioned to perturb a second portion of the wavefront at a second location along the propagation axis different from the first location, where the second portion of the wavefront is at least partially non-overlapping with the first portion of the wavefront.

16. The apparatus of claim 15, wherein each of the plurality of grating elements comprises:
the first portion in contact with the waveguide at the first location and extending along a direction substantially perpendicular to the propagation axis, and
the second portion in contact with the waveguide at the second location and extending along a direction substantially perpendicular to the propagation axis.

17. The apparatus of claim 16, wherein the first portion and the second portion of a particular grating element are connected to each other.

18. The apparatus of claim 15, wherein the first portion and the second portion of a particular grating element are connected to each other.

19. The apparatus of claim 18, wherein each of the plurality of grating elements comprises:
the first portion in contact with the waveguide at a third location and extending to at least the first location, and
the second portion in contact with the waveguide at the third location and extending to at least the second location.

20. The apparatus of claim 18, wherein the particular grating element extends along a substantially straight line that is at an angle that is not perpendicular to the propagation axis.

21. The apparatus of claim 15, further comprising:
at least one optical source port providing an optical wave having a spectral peak wavelength that is tunable;
a plurality transmitting optical phased arrays (OPAs), each transmitting OPA of the plurality of transmitting OPAs:
being coupled to the optical source port,
comprising a plurality of optical phase shifters that are tunable, and a plurality of optical grating antennas, including two or more optical grating antennas each coupled to a different respective one of the optical phase shifters, each of the optical grating antennas comprising a structure substantially identical to the waveguide and the plurality grating elements, and
being configured to form a beam characterized by a wavelength-controlled angular tuning range within a first plane and a phase-shift-controlled angular tuning range within a plane perpendicular to the first plane; and
a plurality of receiving OPAs, each receiving OPA of the plurality of receiving OPAs:
being coupled to a coherent receiver that is coupled to the optical source port,
comprising a plurality of optical phase shifters that are tunable, and a plurality of optical grating antennas, including two or more optical grating antennas each coupled to a different respective one of the optical phase shifters, each of the optical grating antennas comprising a structure substantially identical to the waveguide and the plurality grating elements, and
being configured to receive optical waves from a set of receiving angles characterized by a wavelength-controlled angular tuning range within the first plane and a phase-shift-controlled angular tuning range within a plane perpendicular to the first plane.

22. The apparatus of claim 21, wherein
at least two of the wavelength-controlled angular tuning ranges of the beams of the plurality of transmitting OPAs are at least partially non-overlapping and each of plurality of receiving OPAs has a wavelength-controlled angular tuning range that at least partially overlaps with a wavelength-controlled angular tuning range of at least one of the beams of the plurality of transmitting OPAs, or
at least two of the phase-shift-controlled angular tuning ranges of the beams of the plurality of transmitting OPAs are at least partially non-overlapping and each of plurality of receiving OPAs has a phase-shift-controlled angular tuning range that at least partially overlaps with a phase-shift-controlled angular tuning range of at least one of the beams of the plurality of transmitting OPAs.

23. A method for fabricating an optical device, the method comprising:
forming at least one waveguide configured to guide an optical wave along a propagation axis; and
forming a plurality of grating elements distributed along the waveguide and configured to perturb a portion of the optical wave as it propagates along the waveguide, each of the plurality of grating elements comprising:
a first portion positioned to perturb a first portion of a wavefront of the optical wave at a first location along the propagation axis, and
a second portion positioned to perturb a second portion of the wavefront at a second location along the propagation axis different from the first location, where the second portion of the wavefront is at least partially non-overlapping with the first portion of the wavefront.

24. An apparatus comprising:
at least one optical source port providing an optical wave having a spectral peak wavelength that is tunable;
a plurality transmitting optical phased arrays (OPAs), each transmitting OPA of the plurality of transmitting OPAs:
being coupled to the optical source port,
comprising a plurality of optical phase shifters that are tunable, and a plurality of optical grating antennas, including two or more optical grating antennas each coupled to a different respective one of the optical phase shifters, and
being configured to form a beam characterized by a wavelength-controlled angular tuning range within a first plane and a phase-shift-controlled angular tuning range within a plane perpendicular to the first plane; and
a plurality of receiving OPAs, each receiving OPA of the plurality of receiving OPAs:
being coupled to a coherent receiver that is coupled to the optical source port,
comprising a plurality of optical phase shifters that are tunable, and a plurality of optical grating antennas, including two or more optical grating antennas each coupled to a different respective one of the optical phase shifters, and
being configured to receive optical waves from a set of receiving angles characterized by a wavelength-controlled angular tuning range within the first plane and a phase-shift-controlled angular tuning range within a plane perpendicular to the first plane;
wherein at least two of the wavelength-controlled angular tuning ranges of the beams of the plurality of transmitting OPAs are at least partially non-overlapping and each of plurality of receiving OPAs has a wavelength-controlled angular tuning range that at least partially overlaps with a wavelength-controlled angular tuning range of at least one of the beams of the plurality of transmitting OPAs, or at least two of the phase-shift-controlled angular tuning ranges of the beams of the plurality of transmitting OPAs are at least partially non-overlapping and each of plurality of receiving OPAs has a phase-shift-controlled angular tuning range that at least partially overlaps with a phase-shift-controlled angular tuning range of at least one of the beams of the plurality of transmitting OPAs.

25. The apparatus of claim 24, wherein at least two of the wavelength-controlled angular tuning ranges of the beams of the plurality of transmitting OPAs are at least partially non-overlapping and each of plurality of receiving OPAs has a wavelength-controlled angular tuning range that at least partially overlaps with a wavelength-controlled angular tuning range of at least one of the beams of the plurality of transmitting OPAs.

26. The apparatus of claim 24, wherein at least two of the phase-shift-controlled angular tuning ranges of the beams of the plurality of transmitting OPAs are at least partially non-overlapping and each of plurality of receiving OPAs has a phase-shift-controlled angular tuning range that at least partially overlaps with a phase-shift-controlled angular tuning range of at least one of the beams of the plurality of transmitting OPAs.

27. The apparatus of claim 24, wherein at least two of the wavelength-controlled angular tuning ranges of the beams of the plurality of transmitting OPAs are at least partially non-overlapping and each of plurality of receiving OPAs has a wavelength-controlled angular tuning range that at least partially overlaps with a wavelength-controlled angular tuning range of at least one of the beams of the plurality of transmitting OPAs, and at least two of the phase-shift-controlled angular tuning ranges of the beams of the plurality of transmitting OPAs are at least partially non-overlapping and each of plurality of receiving OPAs has a phase-shift-controlled angular tuning range that at least partially overlaps with a phase-shift-controlled angular tuning range of at least one of the beams of the plurality of transmitting OPAs.

28. The apparatus of claim 24, wherein at least one of the plurality of transmitting OPAs comprises:
at least one waveguide configured to guide an optical wave along a propagation axis;
a plurality of sets of grating elements distributed along the waveguide and configured to perturb a portion of the optical wave as it propagates along the waveguide to emit
a plurality of beams at different respective angles about an axis that is perpendicular to the propagation axis, the plurality of sets of grating elements comprising:
a first set of grating elements with adjacent grating elements separated from each other along the propagation axis by a first length, and
a second set of grating elements with adjacent grating elements separated from each other along the propagation axis by the first length, where the second set of grating elements is separated from the first set of grating elements along the propagation axis by a gap without any grating elements at least twice as large as the first length.

29. The apparatus of claim 28, wherein each grating element of the plurality of sets of grating elements is in contact with a strip of material having substantially the same index of refraction as the grating elements.

30. The apparatus of claim 24, wherein at least one of the plurality of transmitting OPAs comprises:
at least one waveguide configured to guide an optical wave along a propagation axis;
a plurality of grating elements distributed along the waveguide and configured to perturb a portion of the optical wave as it propagates along the waveguide to emit a plurality of beams at different respective angles about an axis that is perpendicular to the propagation axis, the plurality of grating elements comprising:
a first portion positioned to perturb a first portion of a wavefront of the optical wave at a first location along the propagation axis, and
a second portion positioned to perturb a second portion of the wavefront at a second location along the propagation axis different from the first location, where the second portion of the wavefront is at least partially non-overlapping with the first portion of the wavefront.

31. The apparatus of claim 30, wherein the first and the second portion of a particular grating element are connected to each other.

32. A method for managing optical phased array beam steering, the method comprising:
providing, from at least one optical source port, an optical wave having a spectral peak wavelength that is tunable;
transmitting beams from a plurality transmitting optical phased arrays (OPAs), each transmitting OPA of the plurality of transmitting OPAs:
being coupled to the optical source port,
comprising a plurality of optical phase shifters that are tunable, and a plurality of optical grating antennas, including two or more optical grating antennas each coupled to a different respective one of the optical phase shifters, and
being configured to form a beam characterized by a wavelength-controlled angular tuning range within a first plane and a phase-shift-controlled angular tuning range within a plane perpendicular to the first plane; and
receiving optical waves into a plurality of receiving OPAs, each receiving OPA of the plurality of receiving OPAs:
being coupled to a coherent receiver that is coupled to the optical source port,
comprising a plurality of optical phase shifters that are tunable, and a plurality of optical grating antennas, including two or more optical grating antennas each coupled to a different respective one of the optical phase shifters, and
being configured to receive optical waves from a set of receiving angles characterized by a wavelength-controlled angular tuning range within the first plane and a phase-shift-controlled angular tuning range within a plane perpendicular to the first plane;
wherein at least two of the wavelength-controlled angular tuning ranges of the beams of the plurality of transmitting OPAs are at least partially non-overlapping and each of plurality of receiving OPAs has a wavelength-controlled angular tuning range that at least partially overlaps with a wavelength-controlled angular tuning range of at least one of the beams of the plurality of transmitting OPAs, or at least two of the phase-shift-controlled angular tuning ranges of the beams of the plurality of transmitting OPAs are at least partially non-overlapping and each of plurality of receiving OPAs has a phase-shift-controlled angular tuning range that at least partially overlaps with a phase-shift-controlled angular tuning range of at least one of the beams of the plurality of transmitting OPAs.
